(19) United States
(12) Patent Application Publication
(10) Pub. No.: US 2007/0196597 A1
(43) Pub. Date: Aug. 23, 2007

(54) Inorganic fine particle dispersion, method for forming same, ink jet recording medium and method for manufacturing same

(75) Inventors: Kentaro Shiratsuchi, Shizuoka-ken (JP); Tomoya Kubota, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/704,991

(22) Filed: Feb. 12, 2007

(30) Foreign Application Priority Data
Feb. 17, 2006 (JP) 2006-041335

(51) Int. Cl. B41M 5/40; B32B 15/02; B32B 9/04

(52) U.S. Cl. 428/32.34; 428/402; 428/323; 428/447; 428/404; 428/405; 428/32.38

(57) ABSTRACT

The invention provides an inorganic fine particle dispersion having at least an inorganic fine particles, a silane coupling agent, and at least one member selected from the group consisting of a basic inorganic salt and ammonium, the inorganic fine particle dispersion having a pH of 5.0 or less, and a method for forming thereof including at least adjusting the pH by using the basic inorganic salt and/or the ammonium. The invention further provides an ink jet recording medium and a method manufacturing thereof including at least applying an ink-receiving layer coating liquid formed by mixing the inorganic fine particle dispersion and a water-soluble resin onto a support.

### BACKGROUND OF THE INVENTION

1. Technical Field

The invention relates to an inorganic fine particle dispersion, a method for forming the inorganic fine particle dispersion, an ink jet recording medium and a method for manufacturing the ink jet recording medium.

2. Related Art

Recently, ink jet recording methods have been widely used not only in the office, but also in the home because of advantages such as the ability to record on a variety of materials, the comparative inexpensiveness and compactness of hardware (apparatuses) used, the superior quietness thereof and the like.

An ink jet recording medium having an ink-receiving layer having a porous structure is proposed as a recording medium on which photographic like images, in other words high-resolution images, can be formed and which also shows high-gloss.

However, since permeability of oxygen in the ink-receiving layer is significant because of the porous structure, this may accelerate deterioration of the components contained in the ink-receiving layer. Moreover, bleeding of the images may be generated with time due to moisture adsorption to the surface of silica contained in the ink-receiving layer.

In order to solve these problems, there is proposed an ink jet sheet wherein a silane coupling agent is used, whereby images of high resolution and high density can be formed, and besides being excellent in light resistance, water resistance and gas resistance of image portions, images may be stably maintained with no bleeding of images with time even if after printing the images are stored in an environment of high temperature and high humidity for a long period, and is the ink jet sheet has excellent suitability for manufacturing (for example, Japanese Patent Application Laid-Open (JP-A) No. 2003-305944).

Furthermore, an invention wherein a silane coupling agent is used for maintaining the environmental stability of images is proposed (for example, JP-A Nos. 2001-10209 and 2003-276305).

### SUMMARY

An ink-receiving layer is prepared by applying an ink-receiving layer coating liquid onto a support. However, when a silane coupling agent is added to the ink-receiving layer coating liquid, the viscosity thereof may increase so that the stability of the viscosity deteriorates.

The invention has been made in view of the above conventional problems. The invention provides an inorganic fine particle dispersion which can improve the viscosity stability of an ink-receiving layer coating liquid, and a method for manufacturing the same, as well as a method for manufacturing an ink jet recording medium which uses the ink-receiving layer coating liquid excellent in viscosity stability, and the ink jet recording medium obtained by the manufacturing method.

Namely, one aspect of the invention provides an inorganic fine particle dispersion comprising inorganic fine particles, a silane coupling agent, and at least one member selected from the group consisting of a basic inorganic salt and ammonium, the inorganic fine particle dispersion having a pH of 5.0 or less.

Another aspect of the invention provides a method for forming an inorganic fine particle dispersion comprising inorganic fine particles, a silane coupling agent, and at least one member selected from the group consisting of a basic inorganic salt and ammonium, the inorganic fine particle dispersion having a pH of 5.0 or less, the method comprising

adjusting the pH of the dispersion by using the at least one member selected from the group consisting of the basic inorganic salt and the ammonium.

Another aspect of the invention provides a method for manufacturing an ink jet recording medium comprising a support and, provided on the support, an ink-receiving layer that comprises a water-soluble resin, inorganic fine particles, a silane coupling agent, and at least one member selected from the group consisting of a basic inorganic salt and ammonium, the method comprising:

preparing an inorganic fine particle dispersion having a pH of 5.0 or less and comprising the inorganic fine particle, the silane coupling agent, and the at least one member selected from the group consisting of the basic inorganic salt and the ammonium;

preparing an ink-receiving layer coating liquid by mixing the inorganic fine particle dispersion and the water-soluble resin; and

applying the ink-receiving layer coating liquid onto the support to form a coated layer.

Still another aspect of the invention provides an ink jet recording medium comprising a support and, provided on the support, an ink-receiving layer that comprises a water-soluble resin, inorganic fine particles, a silane coupling agent, and at least one member selected from the group consisting of a basic inorganic salt and ammonium,

wherein the ink jet recording medium is manufactured by a method comprising:

preparing an inorganic fine particle dispersion having a pH of 5.0 or less comprising the inorganic fine particles, the silane coupling agent, and the at least one member selected from the group consisting of the basic inorganic salt and the ammonium;

preparing an ink-receiving layer coating liquid by mixing the inorganic fine particles dispersion and the water-soluble resin; and

applying the ink-receiving layer coating liquid onto the support to form a coated layer.

### DETAILED DESCRIPTION OF THE INVENTION

In the following, the inorganic fine particle dispersion according to the invention, and the method for manufacturing the same, as well as the ink jet recording medium, and the method for manufacturing the same will be described.

### The Inorganic Fine Particle Dispersion and the Method for Manufacturing the Same

The inorganic fine particle dispersion of the invention contains inorganic fine particles, a silane coupling agent, and at least one selected from the group consisting of a basic inorganic salt and ammonium, and the pH of the dispersion is 5.0 or less.

As described below, an ink-receiving layer coating liquid is prepared by adding a water-soluble resin and the like to the inorganic fine particle dispersion of the invention. The ink-receiving layer coating liquid containing the inorganic fine particle dispersion of the invention exhibits smaller changes in the viscosity with time so as to provide excellent viscosity stability. Accordingly, when the inorganic fine particle dispersion of the invention is used, an ink-receiving layer coating liquid excellent in viscosity stability can be obtained.

Although the reason why the use of the inorganic fine particle dispersion of the invention results in improvements in the viscosity stability of the ink-receiving layer coating liquid is not clear, it is inferred that the reason of an increase in the viscosity of an ink-receiving layer coating liquid with time is that water-soluble resin contained in the coating liquid is adsorbed onto the inorganic fine particles. Accordingly, by causing the coverage amount of the silane coupling agent on the inorganic fine particles contained in the ink-receiving layer coating liquid to increase, improvement in the viscosity stability of the coating liquid is expected.

The silane coupling agent is adsorbed onto the surfaces of the inorganic fine particles in the inorganic fine particle dispersion, and the adsorption amount thereof is influenced by the presence or not of at least one member of the compounds selected from the group consisting of the basic inorganic salts and ammonia. The presence of the compound brings about an increase of the adsorption amount (coverage amount) of the silane coupling agent onto the surfaces of the inorganic fine particles. It is supposed that, as a result thereof, the viscosity stability of an ink-receiving layer coating liquid using the inorganic fine particle dispersion of the invention is improved.

In addition, since an adsorption amount of the silane coupling agent onto the surfaces of the inorganic fine particles increases, an application amount of the silane coupling agent may be decreased. Further, since there is a decrease in the change in viscosity as time passes, an application amount of a viscosity depressant may be reduced.

Hereinafter, the constituent materials of the inorganic fine particle dispersion of the invention are explained.

### Inorganic Fine Particles

Examples of the inorganic fine particles contained in the inorganic fine particle dispersion of the invention include those of, for example, silica, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide and yttrium oxide. Preferable examples among these include a silica fine particle, colloidal silica, an alumina fine particle and pseudo-boehmite in view of forming an excellent porous structure. The inorganic fine particles may be used in a form of primary particles as they are or in a form of secondary particles. The average primary diameter of the inorganic fine particles is preferably 2 μm or less, and more preferably 200 nm or less.

Further preferable examples of the inorganic fine particles include silica fine particles having the average primary diameter of 20 mn or less, colloidal silica fine particles having the average primary diameter of 30 nm or less, alumina fine particles having the average primary diameter of 20 nm or less, and pseudo-boehmite, the average pore radius of which is in a range of 2 to 15 nm. Particularly preferable examples of the inorganic fine particles include silica fine particles, alumina fine particles and pseudo-boehmite.

Silica fine particles are usually roughly classified into wet method particles and dry method (vapor phase process) particles in accordance with the method for manufacturing thereof. In the mainstream of the wet method, silica fine particles are mainly produced by generating an activated silica by acid decomposition of a silicate, appropriately polymerizing the activated silica, and aggregation precipitation of the resulting polymeric silica to obtain hydrated silica. On the other hand, in the mainstream of the gas phase process, silica (anhydrous silica) particles are produced by either a method having high-temperature gas-phase hydrolysis of a silicon halide (flame hydrolysis process), or a method having reductively heating and vaporizing quartz and coke in an electric furnace, applying an arc discharge and oxidizing the vaporized silica with air (arc method). The “vapor-phase process silica” means an anhydrous silica fine particle produced by the gas phase process. Vapor-phase process silica fine particles are particularly preferable as the silica fine particles used in the invention.

While the above vapor-phase process silica differs from hydrated silica in terms of the density of silanol groups on its surfaces, the presence or not of voids therein, and the like, and different properties are exhibited from each other, vapor-phase process silica is suitable for forming three-dimensional structures which have a high void ratio. While the reason for this is not clearly understood, it can be supposed as follows. Namely, hydrated silica fine particles have a high density of silanol groups on the surface, at 5 to 8 per nm², thus the silica fine particles tend to coagulate (aggregate) densely. In contrast, vapor-phase-process silica particles have a lower density of silanol groups on the surface, at 2 to 3 per nm², thus vapor-phase process silica seems to form less compact, loose coagulations (flocculations), consequently leading to structures with a higher void ratio.

The vapor-phase process silica has a remarkably large specific surface area. Therefore, the vapor-phase process silica has high ink absorption properties and high ink retention efficiency. Further, since the vapor-phase process silica has a low refractive index, when the vapor-phase process silica is dispersed up to a suitable particle diameter, the resulting ink-receiving layer can be made to have transparency, whereby a high color density and good color development are obtained. The transparency of the ink-receiving layer is important not only for applications requiring transparency in OHPs and the like, but also for applications with recording sheets such as gloss photo paper from the viewpoint of achieving a high color density and good color formation gloss.

An average primary particle diameter of the vapor-phase process silica particles is preferably 30 nm or less, more preferably 20 nm or less, particularly preferably 10 nm or less, and the most preferably in a range of 3 to 10 nm. Since the vapor-phase process silica particles easily adhere to each other by hydrogen bonds due to the silanol groups, a structure having a high void ratio can be formed thereby when the average primary particle size is 30 nm or less, whereby the ink absorption characteristic can be effectively improved.

The silica fine particles may be used in combination with other fine particles described above. When the other fine particles are used in combination with the vapor-phase silica, the amount of the vapor-phase silica relative to the total amount of fine particles is preferably 30% or more by mass, and more preferably 50% or more by mass.

Preferable examples of inorganic fine particles which can be additionally used in the invention include alumina fine particles, alumina hydrate, and mixtures or complexes thereof. Among them, alumina hydrate is further preferable, as it absorbs and holds inks well. Pseudo-boemite (Al₂O₃.nH₂O) is particularly preferable. Alumina hydrate may be used in a variety of forms. Alumina hydrate is preferably prepared by using boehmite in the sol state as the starting material, as it easily provides smoother layers.

An average pore radius of pseudo-boemite is preferably in a range of 1 to 30 nm and more preferably in a range of 2 to 15 nm. The pore volume thereof is preferably in a range of 0.3 to 2.0 mg/g, and more preferably in a range of 0.5 to 1.5 mg/g. The average pore radius and the pore volume are determined by the nitrogen absorption-desorption method. These values may be determined, for example, by using a gas absorption-desorption analyzer (e.g., trade name: OMNISORP 369, manufactured by Beckman Coulter, Inc.).

Among alumina fine particles, gas phase alumina fine particles are preferable due to their large specific surface area. The average primary particle diameter of gas phase alumina is preferably 30 nm or less, more preferably 20 nm or less.

If the inorganic fine particles are applied to the ink jet recording medium of the invention, they may be desirably used in the manners disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314.

A content of the inorganic fine particles in the inorganic fine particle dispersion of the invention is preferably in a range of 1 to 50% by mass, more preferably in a range of 5 to 40% by mass, and particularly preferably in a range of 10 to 25% by mass relative to a total weight of the dispersion.

### Silane Coupling Agent

The silane coupling agent contained in the inorganic fine particle dispersion of the invention is not particularly restricted. Examples of the silane coupling agent include the following specific examplary compounds, as well as a cationic polymer-silane coupling agent.

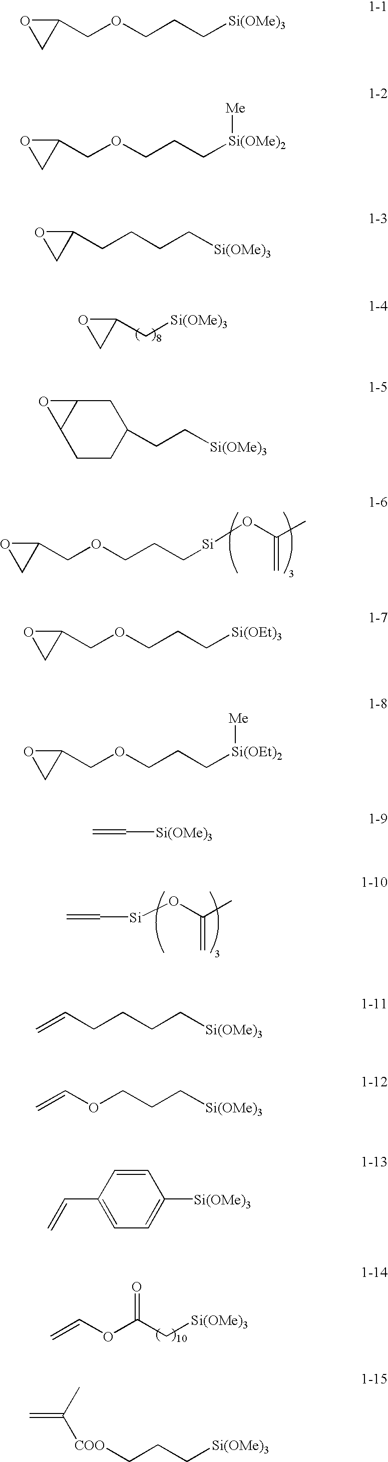

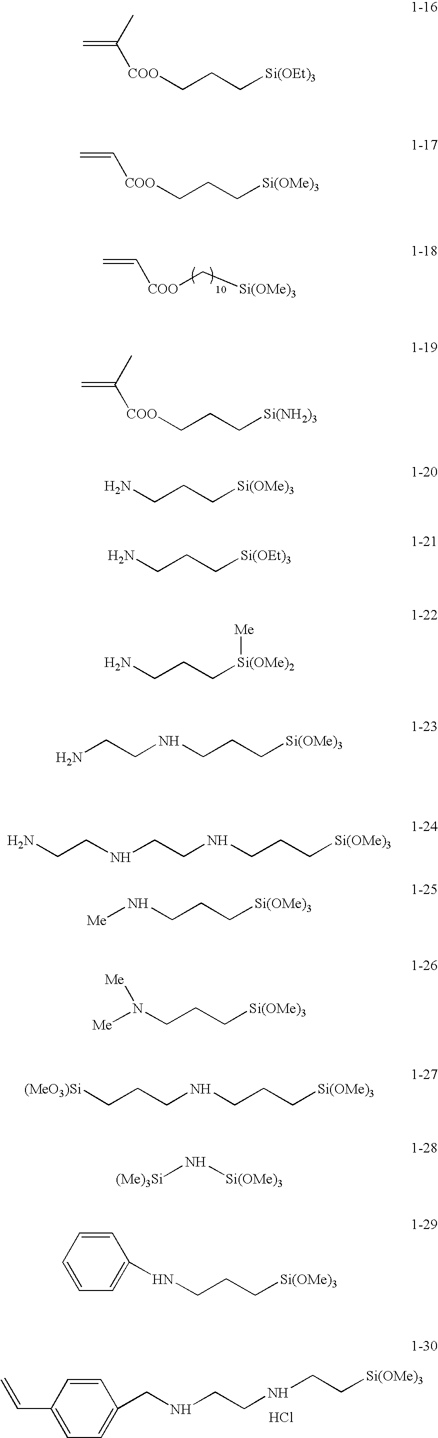

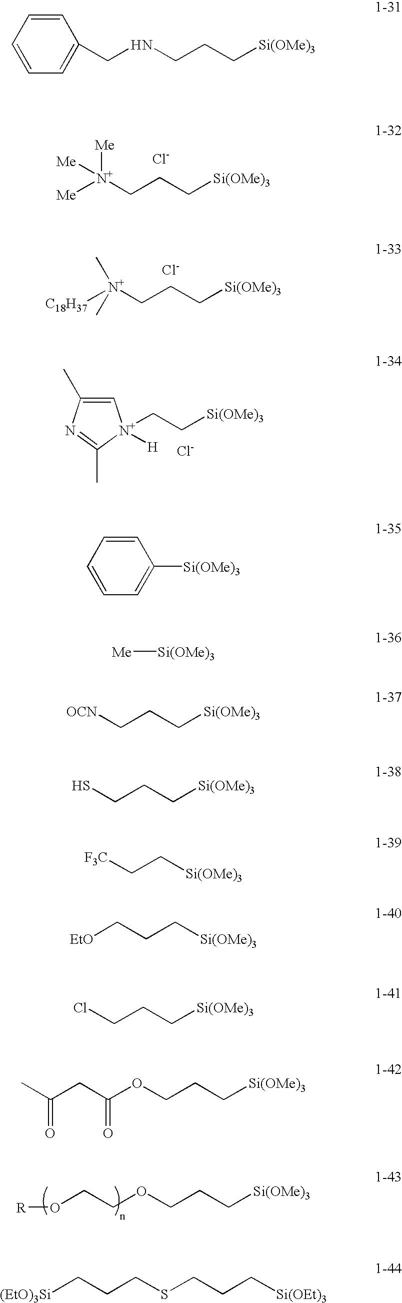

In the exemplary compound 1-43, R represents a hydrogen atom, a substituted or unsubstituted alkyl group, an alkenyl group, an aryl group, an acyl group, a heteroaryl group, or a heterocyclic group; and n represents an integer of 1 or more.

The “cationic polymer-silane coupling agent” used in the invention is a silane coupling agent having a repeating unit provided from cationic monomer unit(s). Examples of the cationic polymer-silane coupling agent used in the invention include the compounds represented by the following Formula (1) or (2).

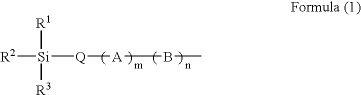

In Formula (1), each of R¹, R², and R³ independently represents a hydrogen atom, an alkyl group which has 1 to 18 carbon atoms and may include a saturated or unsaturated cyclic structure, an alkoxy group which has 1 to 8 carbon atoms and may include a saturated or unsaturated cyclic structure, or an aryloxy group; at least one of R¹, R², and R³ is an alkoxy group or an aryloxy group; Q represents a substituted or unsubstituted divalent linking group having 1 to 18 carbon atoms and which may include adjacent moieties linked through a heteroatom; A represents a repeating unit provided by a cationic monomer; B represents a repeating unit provided by a nonionic monomer; and each of m and n independently represents a mole percentage of the A component or the B component, wherein each of m and n is independently in a range of 0 to 100 mol %.

The alkyl group represented by R¹, R², or R³ has 1 to 18 carbon atoms, and preferably has 1 to 8 carbon atoms. In a case where the alkyl group has 1 to 8 carbon atoms, the reactivity of the cationic polymer-silane coupling agent with respect to the inorganic fine particles can be sufficiently assured. Preferable examples of the alkyl group include a methyl group, an ethyl group, a propyl group, a butyl group, a hexyl group, an octyl group, a decyl group, a dodecyl group, a tetradecyl group, and an octadecyl group; and among others, a methyl group, an ethyl group, a propyl group, and a butyl group are preferable.

The alkoxy group represented by R¹, R², or R³ has 1 to 8 carbon atoms, and preferably 1 to 4 carbon atoms. In a case where the alkoxy group has 1 to 8 carbon atoms, the reactivity thereof with the inorganic fine particles can be sufficiently assured. Preferable examples of the alkoxy group include a methoxy group, an ethoxy group, a propoxy group, a buthoxy group, a hexyloxy group, and an octyloxy group; and among others, a methoxy group, an ethoxy group, and a propoxy group are preferable.

In Formula (1), Q represents a substituted or unsubstituted divalent linking group having 1 to 18 carbon atoms and which may include adjacent moieties linked through a heteroatom. The number of carbon atoms included in Q is preferably in a range of 2 to 8. When the number of carbon atoms is 1 to 18, it can be assured that the cationic polymer-silane coupling agent is sufficiently dissolved into water or alcohol solvents, as well as is capable of exhibiting a sufficient performance. Examples of the substituent include a halogen atom, a hydroxyl group, an amino group, an ester group, an ether group, an amide group and the like. Examples of the heteroatom include an oxygen atom, a nitrogen atom, a sulfur atom, a silicon atom, a phosphorus atom and the like; and among others, an oxygen atom, a nitrogen atom, and a sulfur atom are preferable.

Specific preferable examples of the divalent linking group include a methylene group, an ethylene group, a propylene group, a tetramethylene group, a hexamethylene group, a xylylene group and the like.

In Formula (1), A represents at least one or more repeating unit(s) provided by a cationic monomer(s). Examples of the cationic monomer include trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-N-p-vinylbenzyl ammonium chloride, N,N-diethyl-N-methyl-N-p-vinylbenzyl ammonium chloride, N,N-dimethyl-N-n-propyl-N-p-vinylbenzyl ammonium chloride, N,N-dimethyl-N-n-octyl-N-p-vinylbenzyl ammonium chloride, N,N-dimethyl-N-benzyl-N-p-vinylbenzyl ammonium chloride, N,N-diethyl-N-benzyl-N-p-vinylbenzyl ammonium chloride, N,N-dimethyl-N-(4-methyl)benzyl-N-p-vinylbenzyl ammonium chloride, N,N-dimethyl-N-phenyl-N-p-vinylbenzyl ammonium chloride; trimethyl-p-vinylbenzyl ammonium bromide, trimethyl-m-vinylbenzyl ammonium bromide, trimethyl-p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate; and quaternary products, with methyl chloride, ethyl chloride, methyl bromide, ethyl bromide, methyl iodide or ethyl iodide, of N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylamionoethyl (meth)acrylamide, N,N-dimethylaminopropyl (meth)acrylamide or N,N-diethylaminopropyl (meth)acrylamide, as well as their sulfonates, alkyl sulfonates, acetates or alkyl carboxylates whose anions are substituted.

B in Formula (1) represents at least one or more repeating unit(s) provided by a nonionic monomer(s). Specific examples of the nonionic monomer include alkyl (meth)acrylate esters such as (meth)acrylic acid alkyl esters having 1 to 18 carbon atoms [for example, methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, stearyl (meth)acrylate and the like]; cycloalkyl (meth)acrylate esters [such as cyclohexyl (meth)acrylate or the like]; aryl (meth)acrylate esters [such as phenyl methacrylate or the like]; aralkyl esters [such as benzyl meth(acrylate) or the like]; substituted alkyl (meth)acrylate esters [such as 2-hydroxyethyl (meth)acrylate or the like]; (meth)acrylamides [such as (meth)acrylamide, dimethyl(meth)acrylamide or the like]; aromatic vinyls [such as styrene, vinyltoluene, or α-methylstyrene]; vinyl esters [such as vinyl acetate, vinyl propionate, or vinyl versatate]; allyl esters [such as allyl acetate]; halogen-containing monomers (such as vinylidene chlorides or vinyl chloride]; vinyl cyanide [such as (meth)acrylonitrile]; olefins [such as ethylene or propylene] and the like.

Each of the repeating units represented by A or B in Formula (1) may be formed of one kind of copolymerizable component or a combination of two or more thereof. Any sequences which can be formed by arrangement of the repeating units represented by A or B are included in the scope of the moiety -(A)ₘ-(B)ₙ- in Formula (1) as long as m mol % of the repeating units represented by A and n mol % of the repeating units represented by B are contained therein.

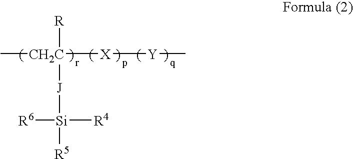

In Formula (2), each of R⁴, R⁵, and R⁶ independently represents a hydrogen atom, an alkyl group which has 1 to 18 carbon atoms and may include a saturated or unsaturated cyclic structure, an alkoxy group which has 1 to 8 carbon atoms and may include a saturated or unsaturated cyclic structure, or an aryloxy group, wherein at least one of R⁴, R⁵, and R⁶ is an alkoxy group or an aryloxy group; J represents a substituted or unsubstituted divalent linking group having 1 to 18 carbon atoms and which may include adjacent moieties linked through a heteroatom; X represents a repeating unit provided by a cationic monomer; Y represents a repeating unit provided by a nonionic monomer; each of r, p, and q represents a mole percentage of the respective repeating unit, wherein r is in a range of 1 to 50 mol %, each of p and q is independently in a range of 0 to 99 mol %; and R represents a hydrogen atom or an alkyl group having 1 to 4 carbon atoms.

The alkyl group represented by R⁴, R⁵, or R⁶ has 1 to 18 carbon atoms, and preferably 1 to 8 carbon atoms. In a case where the alkyl group has 1 to 8 carbon atoms, the reactivity thereof with the inorganic fine particles may be sufficiently assured. Examples of the alkyl group include a methyl group, an ethyl group, a propyl group, a butyl group, a hexyl group, an octyl group, a decyl group, a dodecyl group, a tetradecyl group, and an octadecyl group; and among others, a methyl group, an ethyl group, a propyl group, and a butyl group are preferable.

The alkoxy group represented by R⁴, R⁵, or R⁶ has 1 to 8 carbon atoms, and preferably 1 to 4 carbon atoms. In a case where the alkoxy group has 1 to 8 carbon atoms, the reactivity thereof with the inorganic fine particles may be sufficiently assured. Examples of the alkoxy group include a methoxy group, an ethoxy group, a propoxy group, a buthoxy group, a hexyloxy group, and an octyloxy group; and among others, a methoxy group, an ethoxy group, and a propoxy group are preferable.

J in Formula (2) represents a divalent linking group, and examples thereof include an alkylene group, an allylene group, an aralkylene group, —O—, —COO—, —OCO—, —CONH—, —CONR′— and the combinations thereof, wherein R′ represents any one of an alkyl group, an aryl group, and an aralkyl group.

Specific examples of the monomer having the unit containing the silyl group contained in Formula (2) include vinyltrimethoxysilane, vinyltriethoxysilane, vinyltri(2-methoxyethoxy)silane, vinyldimethoxymethylsilane, 3-(meth)acryloxypropyldimethoxymethylsilane and the like.

In Formula (2), X represents at least one or more repeating unit(s) provided by a cationic monomer(s), and Y represents at least one or more repeating unit(s) provided by a nonionic monomer. Specific examples of X are similar to those of A in Formula (1), and Specific examples of Y are similar to those of B in Formula (1). Any sequences which can be formed by arrangement of the repeating units represented by X or Y are included in the scope of the moiety -(X)ₚ-(Y)_{q}- in Formula (2) as long as p mol % of the repeating units represented by X and q mol % of the repeating units represented by Y are contained therein.

In the inorganic fine particle dispersion of the invention, it is preferable to use the cationic polymer-silane coupling agent represented by Formula (1) or (2) from the following reason.

The cationic polymer-silane coupling agent causes a covalent bonding of a silane coupling portion onto the silica surface and an electrostatic adsorption of a cationic portion onto the silica surface. In addition, the adsorption of PVA can be suppressed by a steric constraint because the silane coupling agent has a form of a polymer, so that the coating liquid viscosity can be efficiently stabilized.

An amount of the inorganic fine particle dispersion of the invention relative to the total amount of the dispersion is preferably in a range of 0.01 to 10% by mass, more preferably in a range of 0.1 to 5% by mass, and particularly preferably in a range of 0.2 to 3% by mass.

### Basic Inorganic Salts

The inorganic fine particle dispersion of the invention contains at least one selected from the group consisting of a basic inorganic salt and ammonium (hereinafter sometimes referred to as an “alkali component of the invention”). In the invention, the “basic inorganic salt” generally refers a substance which can be dissolved into water to produce a hydroxide ion.

Preferable specific examples of the alkali components of the invention include sodium hydroxide, potassium hydroxide, sodium carbonate, potassium carbonate, sodium hydrogencarbonate, potassium hydrogencarbonate, trisodium phosphate, potassium hydroxide, barium hydroxide, calcium oxide, barium oxide, ammonia, ammonium carbonate, ammonium chloride, magnesium hydroxide, copper (II) hydroxide, aluminum hydroxide, iron (III) hydroxide, and aluminum nitride; and among others, sodium hydroxide, potassium hydroxide, sodium carbonate, potassium carbonate, sodium hydrogencarbonate, potassium hydrogencarbonate, ammonia, ammonium carbonate, ammonium chloride, magnesium hydroxide, and aluminum hydroxide are particularly preferable.

Examples of a solvent to be used in the inorganic fine particle dispersion of the invention include water, organic solvents, and a mixed solvent prepared by mixing these. Examples of the organic solvents include alcohols such as methanol, ethanol, n-propanol, i-propanol, or methoxypropanol; ketones such as acetone or methyl ethyl ketone; tetrahydrofuran; acetonitrile, ethyl acetate, toluene and the like.

A pH of the inorganic fine particle dispersion of the invention may be adjusted by applying the alkali component of the invention. While the pH of the inorganic fine particle dispersion of the invention can be 5 or less, it is preferably in a range of 3 to 5, and is particularly preferably in a range of 3.5 to 5.

One of the most preferable embodiments of the dispersion used in the inorganic fine particle dispersion of the invention can be obtained by dispersing the inorganic fine particles with a cationic polymer-silane coupling agent, and by adjusting a pH thereof with a use of ammonium carbonate so as to be in a range of 4.0 to 4.5.

The method for manufacturing the inorganic fine particle dispersion of the invention includes adjusting a pH of the dispersion by means of the alkali component of the invention. The method for adjusting the pH is not particularly restricted, and examples thereof include a method including adding the alkali component of the invention to a liquid in which the inorganic fine particles have been dispersed, and a method including dispersing the inorganic fine particles into a liquid, the pH of which has been previously adjusted by the alkali component of the invention.

A disperser is used for manufacturing the inorganic fine particle dispersion of the invention. Examples of the disperser to be used for obtaining the dispersion include a variety of well-known conventional dispersers such as a high-speed rotation disperser, a medium agitation type disperser (such as ball mill, sand mill or the like), an ultrasonic disperser, a colloid mill disperser, and a high-pressure disperser. An agitation type disperser, a colloid mill disperser, or a high-pressure disperser is preferable from the viewpoint of the efficient dispersion of lump fine particles.

The method for manufacturing the inorganic fine particle dispersion of the invention preferably includes dispersing the inorganic fine particles into a liquid containing the alkali component of the invention. A silane coupling agent may be added to the liquid containing the alkali component of the invention. When the inorganic fine particles are dispersed into the liquid containing the alkali component of the invention, the appearance of lump inorganic fine particles can be prevented.

### Ink Jet Recording Medium and Method for Manufacturing the Same

The method for manufacturing an ink jet recording medium of the invention relates to a method for manufacturing an ink jet recording medium having at least a support and, provided on the support, an ink-receiving layer that has at least a water-soluble resin, inorganic fine particles, a silane coupling agent, and at least one member selected from the group consisting of a basic inorganic salt and ammonium, the method having at least: preparing the inorganic fine particle dispersion of the invention; preparing an ink-receiving layer coating liquid by mixing the inorganic fine particle dispersion and the water-soluble resin; and applying the ink-receiving layer coating liquid onto the support to form a coated layer. The ink jet recording medium of the invention can be manufactured by the method for manufacturing the ink jet recording medium of the invention.

Since the ink-receiving layer coating liquid containing the inorganic fine particle dispersion is excellent in viscosity stability with lapse of time, the following advantage is obtained when the ink-receiving layer coating liquid is used.

Namely, even when the coating liquid after lapse of two to five days from the preparation is used to form the receiving layer, a good coated surface is obtained, whereby the load in the manufacturing can be reduced.

In the following, the constitutional materials of the ink-receiving layer formed from the ink-receiving layer coating liquid according to the invention will be described.

The ink-receiving layer of the ink jet recording medium according to the invention contains a water-soluble resin. Since the ink-receiving layer contains inorganic fine particles and the water-soluble resin, a porous structure is obtained, whereby the absorption performance of the resulting ink is improved. Particularly, when a solid content of the inorganic fine particles relative to a total mass of the ink-receiving layer is 50% by mass or more, which is more preferably more than 60% by mass, it becomes possible to form a better porous structure so as to provide a desirable ink jet recording medium having a sufficient ink absorbability. It is herein noted that the “solid content” in the ink-receiving layer of the inorganic fine particles means a content which is calculated using the mass of the inorganic fine particles relative to a total mass of components other than water in the compositions constituting the ink-receiving layer.

### Water-Soluble Resin

Specific examples of the water-soluble resin include polyvinyl alcohol resins having a hydroxy group as the hydrophilic structural unit [polyvinyl alcohol (PVA), acetoacetyl-modified polyvinyl alcohol, cation-modified polyvinyl alcohol, anion-modified polyvinyl alcohol, silanol-modified polyvinyl alcohol, polyvinyl acetal etc.], cellulosic resins [methylcellulose (MC), ethylcellulose (EC), hydroxyethylcellulose (HEC), carboxymethylcellulose (CMC), hydroxypropylcellulose (HPC), hydroxyethylmethylcellulose, hydroxypropylmethylcellulose, etc.]; chitins; chitosans; starches; ether bond-containing resins [polyethylene oxide (PEO), polypropylene oxide (PPO), polyethylene glycol (PEG), polyvinyl ether (PVE), etc.]; carbamoyl group-containing resins [polyacrylamide (PAAM), polyvinylpyrrolidone (PVP), polyacrylic acid hydrazide, etc.]; and the like.

Specific examples of the water-soluble resin further include resins having a carboxyl group as a dissociative group, such as polyacrylate salts, maleic acid resins, and alginate salts; gelatins or the like.

Among these, particularly polyvinyl alcohol resins are preferred. Examples of the polyvinyl alcohols include those described in Japanese Patent Application Publication (JP-B) Nos. 4-52786, 5-67432, or 7-29479; Japanese Patent No. 2537827; JP-B No. 7-57553; Japanese Patent Nos. 2502998, or 3053231; JP-A No. 63-176173; Japanese Patent No. 2604367; JP-A Nos. 7-276787, 9-207425, 11-58941, 2000-135858, 2001-205924, 2001-287444, 62-278080, and 9-39373; Japanese Patent No. 2750433; or JP-A Nos. 2000-158801, 2001-213045, 2001-328345, 8-324105, or 11-348417.

Examples of the water-soluble resin other than polyvinyl alcohol resins further include compounds described in the paragraph numbers 0011 to 0014 of JP-A No. 11-165461.

These water-soluble resins may be used ingly or in combinations of two or more of them.

The amount of the water soluble resin in the invention is preferably in a range of 9 to 40% by mass, and more preferably in a range of 12 to 33% by mass, relative to the mass of total solids of the ink receiving layer.

The water-soluble resin and the inorganic fine particles, which essentially constitute the ink-receiving layer of the ink jet recording medium of the invention, may be respectively a single raw material or a mixture of a plurality of raw materials.

From the viewpoint of assuring transparency of the ink-receiving layer, a kind of the water-soluble resin to be used in combination with the fine particles, which is particularly the silica fine particles, is important. In a case where the vapor-phase process silica is used, polyvinyl alcohol resins are preferable as the water-soluble resin to be employed. Among these, a polyvinyl alcohol resin which has a saponification degree of 70 to 100% is preferable, and a polyvinyl alcohol resin which has a saponification degree of 80 to 99.5% is particularly preferable.

Each of the polyvinyl alcohol resins contains a hydroxyl group in a structural unit thereof. Since the hydroxyl group and the silanol group on the surfaces of the silica fine particles form a hydrogen bond, a three-dimensional network which includes secondary particles of the silica fine particles as a network chain unit is easily formed. It is thought that the ink-receiving layer having a porous structure with a high void ratio and a sufficient strength is formed due to the formation of the three-dimensional network.

Ink jet recording, the porous ink-receiving layer obtained as described above rapidly absorbs an ink due to capillary phenomenon, whereby completely round dots can be formed without accompanying any ink blurring.

The polyvinyl alcohol resin may be used in combination with other water-soluble resins. In a case where other water-soluble resin is used in combination with the polyvinyl alcohol resin, a content of the polyvinyl alcohol resin is preferably 50% by mass or more, and more preferably 70% by mass or more relative to a total mass of water-soluble resins used in the ink-receiving layer.

### Ratio of Content of Inorganic Fine Particles and Content of Water-Soluble Resin

The film structure and the film strength of the ink-receiving layer are also influenced remarkably by a ratio of mass content [PB ratio (x/y)] of a mass of the inorganic fine particles (x) and that of a water-soluble resin (y). Namely, when the ratio of mass content [PB ratio] increases, there is such a tendency that a void ratio, a pore volume, and a surface area (per unit mass) of the ink-receiving layer increase, while a density and a strength thereof decrease.

In the invention, a ratio of mass content [PB ratio (x/y)] of the ink-receiving layer is preferably in a range of 1.5 to 10 in view of preventing a decrease of the film strength and an appearance of cracking in case of drying which are caused excessively high PB ratios, while preventing a decrease of the ink absorbability which are caused by a decrease in the void ratio resulted by a tendency of clogging of the voids with the resins which are caused excessively low PB ratios.

In a case where a recording sheet passes through a transfer system of an ink jet printer, there is a case where a stress is applied to the recording sheet. Accordingly, it is required that the ink-receiving layer has sufficient film strength. Moreover, when the recording medium is cut into a sheet-form, it is necessary that the ink-receiving layer has sufficient film strength in view of preventing cracking, peeling and the like of the ink-receiving layer. When these cases are taken into consideration, the ratio of mass content (x/y) is more preferably 5 or less, and still further preferably 2 or more in view of ensuring a high-speed ink absorbability when it is used in an ink jet printer.

For example, when a coating liquid prepared by completely dispersing vapor-phase process silica fine particles having an average primary particle diameter of 20 nm or less and a water-soluble resin at a mass ratio (x/y) of 2 to 5 is applied onto a support and dried, a three-dimensional network is formed having secondary particles of the silica fine particles as network chains, whereby a translucent porous film having 30 nm or less average pore diameter, 50 to 80% void ratio, 0.5 ml/g or more specific pore volume, and 100 m²/g or more specific surface area can be easily formed.

### Crosslinking Agent

In the inkjet recording medium of the invention, the ink receiving layer, that is a coated layer containing the inorganic fine particles and the water soluble resin, is preferably a porous layer which further contains a crosslinking agent and hardened by cross-linking reaction of the water soluble resin and the crosslinking agent.

When the water-soluble resin is polyvinyl alcohol, a boron compound is preferably used as a crosslinking agent. Examples of the boron compound include borax, boric acid, borate (for example, orthoborate, InBO₃, ScBO₃, YBO₃, LaBO₃, Mg₃(BO₃)₂, Co₃(BO₃)₂, diborate (for example, Mg₂B₂O₅, Co₂B₂O₅), metaborate (for example, LiBO₂, Ca(BO₂)₂, NaBO₂, KBO₂), tetraborate (for example, Na₂B₄O₇.10H₂O), pentaborate (for example, KB₅O₈.4H₂O, Ca₂B₆O₁₁.7H₂), CsB₅O₅) and the like. Among these compounds, borax, boric acid and borate are preferable, and boric acid is particularly preferable in view of rapidly causing the cross-linking reaction.

Examples of the crosslinking agent for the water-soluble resin further include compounds other than the boron compound.

Examples of such compounds include aldehyde compounds such as formaldehyde, glyoxal or glutaraldehyde; ketone compounds such as diacetyl or cyclopentanedione; activated halogenated compounds such as bis(2-chloroethyl)urea-2-hydroxy-4,6-dichloro-1,3,5-triazine or sodium salt of 2,4-dichloro-6-s-triazine; activated vinyl compounds such as divinylsulfonate, 1,3-bis(vinylsulfonyl)-2-propanol, N,N′-ethylenebis(vinylsulfonylacetamide), or 1,3,5-triacryloyl-hexahydro-s-triazine; N-methylol compounds such as dimethylol urea or methylol dimethyl hydantoin; melamine compounds such as methylol melamine or alkylated methylol melamine; epoxy resins;

isocyanate compounds such as 1,6-hexamethylene; aziridine compounds described in U.S. Pat. No. 3,017,280 or U.S. Pat. No. 2,983,611; carboxyimide compounds described in U.S. Pat. No. 3,100,704; epoxy compounds such as glycerol triglycidylether; ethyleneimino compounds such as 1,6-hexamethylene-N,N′-bis-ethylene urea; halogenated carboxyaldehyde compounds such as mucochloric acid or mucophenoxychloric acid; dioxane compounds such as 2,3-dihydroxydioxane; metal-containing compounds such as titanium lactate, aluminum sulfate, chrome alum, potassium alum, zirconium acetate or chrome acetate; polyamine compounds such as tetraethylene pentamine; hydrazide compounds such as adipate dihydrazide; and a low molecular-weight molecule or a polymer having two or more oxazoline group.

The crosslinking agent may be used singly or in combination of two or more thereof.

In a case where a boron compound is used as the crosslinking agent in the invention, the addition of the crosslinking agent is preferably conducted as follows. Namely, it is desirable that the ink-receiving layer is a layer cured by crosslinking a coated layer formed by coating an ink-receiving layer coating liquid (hereinafter sometimes referred to as a “first coating liquid”) containing the inorganic fine particles of the invention, a water-soluble resin containing a polyvinyl alcohol, and a boron compound; and the curing of the layer by crosslinking is conducted in such a manner that a basic coating liquid having a pH of 7.1 or more (hereinafter sometimes referred to as “second coating liquid”) is applied onto the coated layer at a time of any one of: (1) at the same time as the coating liquid is applied; (2) during a period in which the coated layer is being dried the coated layer has not exhibited a decreasing rate of drying; and (3) after the coated layer is dried to form a coating film.

An applied amount of the crosslinking agent is preferably in a range of 1 to 50% by mass, and more preferably in a range of 5 to 40% by mass with respect to the water-soluble resin.

In view of improving a water-proof property and a property of blurring-prevention after time passage, the ink-receiving layer preferably further contains a mordant. The mordant is preferably a cationic polymer (cationic mordant) or an inorganic mordant. By the presence of such a mordant in the ink layer the ink can be stabilized by the interaction of the mordant with anionic dyes in liquid inks, giving an improvement in the water-proof property and resistance to blurring after time passage. The organic mordants and the inordanic mordants can be used singly or in combinations with organic mordants and/or inorganic mordants.

A mordant may be added to the ink-receiving layer coating liquid (the first coating liquid) that includes inorganic fine particles and water-soluble resin. Alternatively, a mordant it may be added to the second coating liquid in the case where there is a concern that it may form an aggregation with the inorganic fine particles. Furthermore, a mordant may be added to both the first and second coating liquids where the mordant contained in the first coating liquid may be the same as or different from that contained in the second coating liquid.

While preferable examples of the cationic mordant include a polymer mordant having a primary- to tertiary- amino group or a quaternary ammonium base as a cationic group, a cationic non-polymer mordant can also be used.

Preferable examples of the polymer mordant include a homopolymer of a monomer (mordant monomer) having either a primary to tertiary amino group or a salt thereof or a quaternary ammonium base, and a copolymer or a polycondensate of the mordant monomer and another monomer (referred to hereinafter as “non-mordant monomer”). These polymer mordants can be used either in the form of a water-soluble polymer or in the form of water-dispersible latex particles.

Examples of the monomer (mordant monomer) include trimethyl-p-vinylbenzyl ammonium chloride, trimethyl-m-vinylbenzyl ammonium chloride, triethyl-p-vinylbenzyl ammonium chloride, triethyl-m-vinylbenzyl ammonium chloride, N,N-dimethyl-N-ethyl-N-p-vinylbenzyl ammonium chloride, N,N-diethyl-N-methyl-N-p-vinylbenzyl ammonium chloride, N,N-dimethyl-N-n-propyl-N-p-vinylbenzyl ammonium chloride, N,N-dimethyl-N-n-octyl-N-p-vinylbenzyl ammonium chloride, N,N-dimethyl-N-benzyl-N-p-vinylbenzyl ammonium chloride, N,N-diethyl-N-benzyl-N-p-vinylbenzyl ammonium chloride, N,N-dimethyl-N-(4-methyl)benzyl-N-p-vinylbenzyl ammonium chloride, N,N-dimethyl-N-phenyl-N-p-vinylbenzyl ammonium chloride;

trimethyl-p-vinylbenzyl ammonium bromide, trimethyl-m-vinylbenzyl ammonium bromide, trimethyl-p-vinylbenzyl ammonium sulfonate, trimethyl-m-vinylbenzyl ammonium sulfonate, trimethyl-p-vinylbenzyl ammonium acetate, trimethyl-m-vinylbenzyl ammonium acetate, N,N,N-triethyl-N-2-(4-vinylphenyl)ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl)ethyl ammonium acetate;

and quaternary products, with methyl chloride, ethyl chloride, methyl bromide, ethyl bromide, methyl iodide or ethyl iodide, of N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylamionoethyl (meth)acrylamide, N,N-dimethylaminopropyl (meth)acrylamide or N,N-diethylaminopropyl (meth)acrylamide, as well as their sulfonates, alkyl sulfonates, acetates or alkyl carboxylates whose anions are substituted.

Specific examples of the mordant include monomethyldiallyl ammonium chloride, trimethyl-2-(methacryloyloxy)ethyl ammonium chloride, triethyl-2-(methacryloyloxy)ethyl ammonium chloride, trimethyl-2-(acryloyloxy)ethyl ammonium chloride, triethyl-2-(acryloyloxy)ethyl ammonium chloride, trimethyl-3-(methacryloyloxy)propyl ammonium chloride, triethyl-3-(methacryloyloxy)propyl ammonium chloride, trimethyl-2-(methacryloylamino)ethyl ammonium chloride, triethyl-2-(methacryloylamino)ethyl ammonium chloride, trimethyl-2-(acryloylamino)ethyl ammonium chloride, triethyl-2-(acryloylamino)ethyl ammonium chloride, trimethyl-3-(methacryloylamino)propyl ammonium chloride, triethyl-3-(methacryloylamino)propyl ammonium chloride, trimethyl-3-(acryloylamino)propyl ammonium chloride, triethyl-3-(acryloylamino)propyl ammonium chloride;

N,N-dimethyl-N-ethyl-2-(methacryloyloxy)ethyl ammonium chloride, N,N-diethyl-N-methyl-2-(methacryloyloxy)ethyl ammonium chloride, N,N-dimethyl-N-ethyl-3-(acryloyloxylamino)propyl ammonium chloride, trimethyl-2-(methacryloyloxy)ethyl ammonium bromide, trimethyl-3-(acryloyloxylamino)propyl ammonium bromide, trimethyl-2-(methacryloyloxy)ethyl ammonium sulfonate, trimethyl-3-(acryloylamino)propyl ammonium acetate and the like.

Examples of the copolymerizable monomer further include N-vinylimidazole, N-vinyl-2-methylimidazole and the like.

Allyl amine compounds, diallyl amine compounds, and salts thereof can also be used. Examples of such compounds include allyl amine, allylamine hydrochloride, allylamine acetate, allylamine sulfate, diallyl amine, diallylamine hydrochloride, diallylamine acetate, diallylamine sulfate, diallyl methylamine and salts thereof (for example, hydrochloride, acetate, sulfate etc.), diallyl ethylamine and salts thereof (for example, hydrochloride, acetate, sulfate etc.) and diallyldimethyl ammonium salts (whose counter-anions are hydrochloride, acetate, sulfate or the like). These allyl amine compounds and diallyl amine compounds in an amine form are inferior in polymerizability, and are thus polymerized generally in a salt form and then desalted if necessary.

A mordant obtained by polymerizing a unit such as N-vinyl acetamide or N-vinyl formamide and then hydrolyzing the resulting polymer into vinyl amine units, or a salt thereof, can also be used.

The non-mordant monomer refers to a monomer not containing a basic or cationic moiety such as a primary to tertiary amino group or salt thereof or a quaternary ammonium base, and not interacting or insubstantially interacting with a dye in an ink-jet ink.

The non-mordant monomer includes, for example, (meth)acrylates; cycloalkyl (meth)acrylates such as cyclohexyl (meth)acrylate; aryl (meth)acrylates such as phenyl (meth)acrylate; aralkyl esters such as benzyl (meth)acrylate; aromatic vinyls such as styrene, vinyl toluene, or α-methyl styrene; vinyl esters such as vinyl acetate, vinyl propionate, or vinyl versatate; allyl esters such as allyl acetate; halogen-containing monomers such as vinylidene chloride or vinyl chloride; vinyl cyanides such as (meth)acrylonitrile; and olefins such as ethylene or propylene.

The alkyl (meth)acrylates are preferably alkyl (meth)acrylates having an alkyl moiety containing 1 to 18 carbon atoms, and examples thereof include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate and stearyl (meth)acrylate.

In particular, methyl acrylate, ethyl acrylate, methyl methacrylate, ethyl methacrylate and hydroxyethyl methacrylate are preferable.

The non-mordant monomers can be used alone or as in a combination of two or more thereof.

Preferable examples of the polymer mordant further include polydiallyl dimethyl ammonium chloride, polymethacryloyloxyethyl-β-hydroxyethydimethyl ammonium chloride, polyethylene imine, polyallylamine and modified compounds thereof, polyamide-polyamine resin, cationized starch, dicyandiamide formalin condensate, polymer of dimethyl-2-hydroxypropyl ammonium salt, polyamidine, polyvinylamine, cationic dicyan compound resins such as dicyandiamide formalin condensate, cationic polyamine compound resins such as dicyandiamide diethylenetriamine polycondensate, addition polymer of epichlorohydrine-dimethylamine, polymer of dimethyldiallylammonium chloride-SO_{2,} polymer of diallylamine salt —SO_{2,} (meth)acrylate-containing polymer having a quaternary ammonium base-substituted alkyl group at an ester moiety thereof, and styryl polymer having a quaternary ammonium base-substituted alkyl group at an ester moiety thereof.

Specific examples of the polymer mordant include those described in JP-A No. 48-28325, JP-A No. 54-74430, JP-A No. 54-124726, JP-A No. 55-22766, JP-A No. 55-142339, JP-A No. 60-23850, JP-A No. 60-23851, JP-A No. 60-23852, JP-A No. 60-23853, JP-A No. 60-57836, JP-A No. 60-60643, JP-A No. 60-118834, JP-A No. 60-122940, JP-A No. 60-122941, JP-A No. 60-122942, JP-A No. 60-235134, JP-A No. 1-161236, U.S. Pat. No. 2,484,430, U.S. Pat. No. 2,548,564, U.S. Pat. No. 3,148,061, U.S. Pat. No. 3,309,690, U.S. Pat. No. 4,115,124, U.S. Pat. No. 4,124,386, U.S. Pat. No. 4,193,800, U.S. Pat. No. 4,273,853, U.S. Pat. No. 4,282,305, U.S. Pat. No. 4,450,224, JP-A No. 1-161236, JP-A No. 10-81064, JP-A No. 10-119423, JP-A No. 10-157277, JP-A No. 10-217601, JP-A No. 11-348409, JP-A No. 2001-138621, JP-A No. 2000-43401, JP-A No. 2000-211235, JP-A No. 2000-309157, JP-A No. 2001-96897, JP-A No. 2001-138627, JP-A No. 11-91242, JP-A No. 8-2087, JP-A No. 8-2090, JP-A No. 8-2091, JP-A No. 8-2093, JP-A No. 8-174992, JP-A No. 11-192777, JP-A No. 2001-301314, JP-B No. 5-35162, JP-B No. 5-35163, JP-B No. 5-35164, JP-B No. 5-88846, JP-A No. 7-118333, JP-A No. 2000-344990, and JP Patent Nos. 2648847 and 2661677. Among these, polyallylamine and modified compounds thereof are particularly preferable.

Polyallylamine having the weight average molecular weight of 100,000 or less and modified compounds thereof are particularly preferable as the organic mordant used in the invention in view of preventing blurring after time passage.

A variety of well-known allylamine polymers and modified compounds thereof may be used for the polyallylamines and modified compounds thereof to be used in the invention. Examples of the modified compounds include a salt of a polyallylamine and an acid (examples of the acids include inorganic acids such as hydrochloric acid, sulfuric acid, phosphoric acid, or nitric acid; organic acids such as methanesulfonic acid, toluenesulfonic acid, acetic acid, propionic acid, cinnamic acid, or (meth)acrylic acid; and the combinations thereof); salts of a portion of allylamines; a compound modified by a polymer reaction of polyallylamines; and a copolymer obtained from a polyallylamine and other copolymerizable monomers (Examples of the monomer include (meth)acrylic esters, styrenes, (meth)acrylamides, acrylonitrile, vinyl esters and the like).

Specific examples of the polyallylamine and modified compounds thereof include those described in JP-B Nos. 62-31722, 2-14364, 63-43402, 63-43403, 63-45721, 63-29881, 1-26362, 2-56365, 2-57084, 4-41686, 6-2780, 6-45649, 6-15592, or 4-68622; Japanese Patent Nos. 3199227 or 3008369; JP-A Nos. 10-330427, 11-21321, 2000-281728, 2001-106736, 62-256801, 7-173286, 7-213897, 9-235318, 9-302026, or 11-21321; WO99/21901 or WO99/19372; JP-A No. 5-140213; and Published Japanese Patent No. 11-506488.

An inorganic mordant can also be used as the mordant in the invention, and examples thereof includes polyvalent water-soluble metal salts and hydrophobic metal salts. Examples of the inorganic mordant include salts or complexes of a metal selected from magnesium, aluminum, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten and bismuth.

Specific examples of such compounds include calcium acetate, calcium chloride, calcium formate, calcium sulfate, barium acetate, barium sulfate, barium phosphate, manganese chloride, manganese acetate, manganese formate.2H₂O, ammonium manganese sulfate.6H₂O, copper(II) chloride, copper(II) ammonium chloride.2H₂O, copper sulfate, cobalt chloride, cobalt thiocyanate, cobalt sulfate, nickel sulfate.6H₂O, nickel chloride.6H₂O, nickel acetate.4H₂O, ammonium nickel sulfate.6H₂O, nickel amidosulfate.4H₂O, aluminum sulfate, aluminum alum, basic polyaluminum hydroxide, aluminum sulfite, aluminum thiosulfate, polyaluminum chloride, aluminum nitrate.9H₂O, aluminum chloride.6H₂O, ferrous bromide, ferrous chloride, ferric chloride, ferrous sulfate, ferric sulfate, zinc phenolsulfonate, zinc bromide, zinc chloride, zinc nitrate.6H₂O, zinc sulfate, titanium tetrachloride, tetraisopropyl titanate, titanium acetylacetonate, titanium lactate, zirconium acetylacetonate, zirconyl acetate, zirconyl sulfate, ammonium zirconium carbonate, zirconyl stearate, zirconyl octylate, zirconyl nitrate, zirconium oxychloride, zirconium hydroxychloride, chrome acetate, chrome sulfate, magnesium sulfate, magnesium chloride.6H₂O, magnesium citrate.9H₂O, sodium phosphotungstate, tungsten sodium citrate, 12-tungustophosphoric acid.nH₂O, 12-tungstosilicic acid.26H₂O, molybdenum chloride, 12-molybdophoshoric acid.nH₂O, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride and bismuth nitrate.

The inorganic mordant is preferably an aluminum-containing compound, a titanium-containing compound, a zirconium-containing compound, or a compound (salt or complex) of the group IIIB metals in the periodic table.

The amount of the mordant contained in the ink-receiving layer in the invention is preferably in the range of 0.01 g/m² to 5 g/m^{2,} and more preferably in the range of 0.1 g/m² to 3 g/m^{2.}

### Other Components

If necessary, the image-receiving material of the invention can further contain a wide variety of conventionally-known additives such as an acid, a UV absorber, an antioxidant, a fluorescent brightener, a monomer, a polymerization initiator, a polymerization inhibitor, a blurring inhibitor, a preservative, a viscosity stabilizer, a defoaming agent, a surfactant, an antistatic agent, a matting agent, a curling inhibitor, or a water resistance-conferring agent.

In the invention, the ink-receiving layer may contain an acid. The acid can be added to the ink-receiving layer to adjust the pH of the surface thereof to be in a range of 3 to 8, and preferably to be in a range of 5 to 7.5. The pH adjustment is preferable in view of improving resistance against yellowing in a white background portion of the ink-receiving layer. The measurement of a surface pH is implemented in accordance with A-method (coating method) among the methods for measuring surface pH established by Japan Technical Association of the Pulp and Paper Industry (J. TAPPI). For instance, the measurement may be conducted by the use of a pH measurement set “FORMAT MPC” (trade name, manufactured by Kyoritsu Chemical-Check Lab., Corp.) for measuring a pH on the paper surface which accords to the A-method.

Specific examples of the acid include formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, glutaric acid, gluconic acid, lactic acid, aspartic acid, glutamic acid, salicylic acid, metal salicylate (salicylate salts such as those of Zn, Al, Ca or Mg), methanesulfonic acid, itaconic acid, benzenesulfonic acid, toluenesulfonic acid, trifluoromethanesulfonic acid, styrenesulfonic acid, trifluoroacetic acid, barbituric acid, acrylic acid, methacrylic acid, cinnamic acid, 4-hydroxybenzoic acid, aminobenzoic acid, naphthalenedisulfonic acid, hydroxybenzenesulfonic acid, toluenesulfinic acid, benzenesulfinic acid, sulfanilic acid, sulfamic acid, α-resorcylic acid, β-resorcylic acid, γ-resorcylic acid, gallic acid, fluoroglycine, sulfosalicylic acid, ascorbic acid, erysorbic acid, bisphenolic acid, hydrochloric acid, nitric acid, sulfuric acid, phosphoric acid, polyphosphoric acid, boric acid and boronic acid. The amount of these acids to be added may be determined such that the pH of the surface of the ink-receiving layer is adjusted to be in a range of 3 to 8.

The acid may be used in the form of a metal salt (for example, a salt of sodium, potassium, calcium, cesium, zinc, copper, iron, aluminum, zirconium, lanthanum, yttrium, magnesium, strontium or cerium) or an amine salt (for example, ammonia, triethylamine, tributylamine, piperazine, 2-methylpiperazine, or polyallylamine).

The image-receiving material of the invention preferably further contains agents for improving preservability such as a UV absorber, an antioxidant, a blurring inhibitor or the like.

Examples of the UV absorber, antioxidant and blurring inhibitor include alkylated phenol compounds (including hindered phenol compounds), alkylthiomethyl phenol compounds, hydroquinone compounds, alkylated hydroquinone compounds, tocopherol compounds, thiodiphenylether compounds, compounds having two or more thioether bonds, bisphenol compounds, O—, N— or S— benzyl compounds, hydroxybenzyl compounds, triazine compounds, phosphonate compounds, acylaminophenol compounds, ester compounds, amide compounds, ascorbic acid, amine compound antioxidants, 2-(2-hydroxyphenyl)benzotriazole compounds, 2-hydroxybenzophenone compounds, acrylate, water-soluble or hydrophobic metal salts, organometallic compounds, metal complexes, hindered amine compounds (including TEMPO compounds), 2-(2-hydroxyphenyl)-1,3,5-triazine compounds, metal inactivating agents, phosphite compounds, phosphonite compounds, hydroxyamine compounds, nitron compounds, peroxide scavengers, polyamide stabilizers, polyether compounds, basic assistant stabilizers, nucleating agents, benzofuranone compounds, indolinone compounds, phosphine compounds, polyamine compounds, thiourea compounds, urea compounds, hydrazide compounds, amidine compounds, sugar compounds, hydroxybenzoic acid compounds, dihydroxybenzoic acid compounds and trihydroxybenzoic acid compounds.

Preferable examples among these include alkylated phenol compounds, compounds having two or more of thioether bonds, bisphenol compounds, ascorbic acid, amine compound antioxidants, water-soluble or hydrophobic metal salts, organometallic compounds, metal complexes, hindered amine compounds, hydroxyamine compounds, polyamine compounds, thiourea compounds, hydrazide compounds, hydroxybenzoic acid compounds, dihydroxybenzoic acid compounds and trihydroxybenzoic acid compounds.

Examples of such compounds include those described in JP-A No. 2002-13005, JP-A No. 10-182621, JP-A No. 2001-260519, JP-B No. 4-34953, JP-B No. 4-34513, JP-A No. 11-170686, JP-B No. 4-34512, EP1138509, JP-A No. 60-67190, JP-A No. 7-276808, JP-A No. 2001-94829, JP-A No. 47-10537, JP-A No. 58-111942, JP-A No. 58-212844, JP-A No. 59-19945, JP-A No. 59-46646, JP-A No. 59-109055, JP-A No. 63-53544, JP-B No. 36-10466, JP-B No. 42-26187, JP-B No. 48-30492, JP-B No. 48-31255, JP-B No. 48-41572, JP-B No. 48-54965, JP-B No. 50-10726, U.S. Pat. No. 2,719,086, U.S. Pat. No. 3,707,375, U.S. Pat. No. 3,754,919, U.S. Pat. No. 4,220,711,

JP-B No. 45-4699, JP-B No. 54-5324, European Patent Laid-Open Nos. 223739, 309401, 309402, 310551, 310552 and 459416, German Patent Laid-Open No. 3435443, JP-A No. 54-48535, JP-A No. 60-107384, JP-A No. 60-107383, JP-A No. 60-125470, JP-A No. 60-125471, JP-A No. 60-125472, JP-A No. 60-287485, JP-A No. 60-287486, JP-A No. 60-287487, JP-A No. 60-287488, JP-A No. 61-160287, JP-A No. 61-185483, JP-A No. 61-211079, JP-A No. 62-146678, JP-A No. 62-146680, JP-A No. 62-146679, JP-A No. 62-282885, JP-A No. 62-262047, JP-A No. 63-051174, JP-A No. 63-89877, JP-A No. 63-88380, JP-A No. 66-88381, JP-A No. 63-113536,

JP-A No. 63-163351, JP-A No. 63-203372, JP-A No. 63-224989, JP-A No. 63-251282, JP-A No. 63-267594, JP-A No. 63-182484, JP-A No. 1-239282, JP-A No. 2-262654, JP-A No. 2-71262, JP-A No. 3-121449, JP-A No. 4-291685, JP-A No. 4-291684, JP-A No. 5-61166, JP-A No. 5-119449, JP-A No. 5-188687, JP-A No. 5-188686, JP-A No. 5-110490, JP-A No. 5-170361, JP-B No. 48-43295, JP-B No. 48-33212, U.S. Pat. No. 4,814,262 and U.S. Pat. No. 4,980,275.

The other components described above may be used alone or as in a combination of two or more thereof. The other components may be added after being rendered water-soluble or dispersible, or may be formed into a polymer dispersion, an emulsion or oil droplets, or encapsulated in microcapsules. The amount of the other components added to the image-receiving material of the invention is preferably 0.01 to 10 g/m².

In the invention, the ink-receiving layer coating liquid preferably contains a surfactant. The surfactant used may be a cationic, anionic, nonionic, amphoteric, fluorine or silicon surfactant.

Examples of the nonionic surfactant include polyoxyalkylene alkyl ethers and polyoxyalkylene alkyl phenyl ethers (for example, diethylene glycol monoethyl ether, diethylene glycol diethyl ether, polyoxyethylene lauryl ether, polyoxyethylene stearyl ether, polyoxyethylene nonyl phenyl ether etc.), oxyethylene-oxypropylene block copolymers, sorbitan fatty esters (for example, sorbitan monolaurate, sorbitan monooleate, sorbitan trioleate etc.), polyoxyethylene sorbitan fatty esters (for example, polyoxyethylene sorbitan monolaurate, polyoxyethylene sorbitan monooleate, polyoxyethylene sorbitan trioleate etc.), polyoxyethylene sorbitol fatty esters (for example, polyoxyethylene sorbitol tetraoleate etc.), glycerin fatty esters (for example, glycerol monooleate etc.), polyoxyethylene glycerin fatty esters (polyoxyethylene glycerin monostearate, polyoxyethylene glycerin monooleate etc.), polyoxyethylene fatty esters (polyethylene glycol monolaurate, polyethylene glycol monooleate etc.) and polyoxyethylene alkyl amines, acetylene glycols (for example, 2,4,7,9-tetramethyl-5-decyn-4,7-diol, and ethylene oxide adducts of the diols, propylene oxide addition products) etc. Among these, polyoxyalkylene alkyl ethers are preferable. The nonionic surfactant can be used in both the first and second coating liquids. The nonionic surfactants may be used singly or in combination of two or more thereof.

Examples of the amphoteric surfactant include amino acid amphoteric surfactants, carboxy ammonium betaine amphoteric surfactants, sulfone ammonium betaine amphoteric surfactants, ammonium sulfate betaine amphoteric surfactants and imidazolium betaine amphoteric surfactants, and preferable examples thereof include the surfactants described in U.S. Pat. No. 3,843,368, JP-A No. 59-49535, JP-A No. 63-236546, JP-A No. 5-303205, JP-A No. 8-262742, JP-A No. 10-282619 or the like. The amphoteric surfactants are preferably amino acid amphoteric surfactants. Examples of the amino acid amphoteric surfactant include N-aminoacylic acid and salts thereof formed by modifying amino acids (such as glycine, glutamic acid, histidic acid or the like) and incorporating a long-chained acyl group as described in JP-A No. 5-303205. The amphoteric surfactants may be used singly or in combination of two or more thereof.

Examples of the anionic surfactant include aliphatic acid salts (for example, sodium stearate and potassium oleate), alkyl sulfates (for example, sodium laurylsulfate and lauryl sulfate triethanolamine), sulfonates (for example, sodium dodecylbenzenesulfonate), alkylsulfosuccinates (for example, sodium dioctylsulfosuccinate), alkyl diphenyl ether disulfonates, alkyl phosphates and the like.

The cationic surfactant includes alkylamine salts, quaternary ammonium salts, pyridinium salts, imidazolium salts and the like.

Examples of the fluorine surfactant include compounds derived from intermediates having a perfluoroalkyl group by using a method such as electrolytic fluorination, telomerization or oligomerization.

Specific examples thereof include perfluoroalkyl sulfonates, perfluoroalkyl carboxylates, perfluoroalkyl ethylene oxide adducts, perfluoroalkyl trialkyl ammonium salts, perfluoroalkyl group-containing oligomers, perfluoroalkyl phosphates and the like.

The silicon surfactant is preferably silicon oil modified with an organic group, which may have a siloxane structure which is modified, with organic groups, at any one of side chains, both ends or one end thereof. Examples of the modification with an organic group include modification with an amino group, a polyether group, an epoxy group, a carboxyl group, a carbinol group, an alkyl group, an aralkyl group, a phenol group a fluorine group and the like.

In the invention, the content of the surfactant is preferably 0.001 to 2.0%, more preferably 0.01 to 1.0%, based on the amount of ink-receiving layer coating liquid. When two or more solutions are used as the ink-receiving layer coating liquid, the surfactant is added preferably to both the coating liquids.

In the invention, the ink-receiving layer contains an organic solvent having a high boiling point in view of preventing curling. The high-boiling point organic solvent is a water-soluble or hydrophobic organic compound having a boiling point of 150° C. or more at normal pressures. The high-boiling point organic compound may be a low molecule compound or a polymer and may be in the form of liquid or solid at room temperature.

Specific examples thereof include aromatic carboxylates (such as dibutyl phthalate, diphenyl phthalate, phenyl benzoate or the like), aliphatic carboxylates (such as dioctyl adipate, dibutyl sebacate, methyl stearate, dibutyl maleate, dibutyl fumarate, triethyl acetylcitrate or the like.), phosphates (such as trioctyl phosphate, tricresyl phosphate or the like), epoxy compounds (such as epoxylated soybean oil, epoxylated methyl fatty ester or the like), alcohols (such as stearyl alcohol, ethylene glycol, propylene glycol, diethylene glycol, triethylene glycol, glycerin, diethylene glycol monobutyl ether (DEGMBE), triethylene glycol monobutyl ether, glycerin monomethyl ether, 1,2,3-butane triol, 1,2,4-butane triol, 1,2,4-pentane triol, 1,2,6-hexane triol, thiodiglycol, triethanol amine, polyethylene glycol or the like), vegetable oils (such as soybean oil, sunflower oil or the like) and higher aliphatic carboxylic acids (such as linolic acid, oleic acid or the like).

### Substrate

Either a transparent substrate made of a transparent material such as plastic or an opaque substrate made of an opaque material such as paper may be used as the substrate for the recording medium according to the invention. Use of a transparent substrate or an opaque substrate having high glossiness is preferable for taking the advantage of transparency of the ink-receiving layer. It is also possible to form an ink-receiving layer on a surface of an optical disk on which the label is provided by using, as the substrate, a read-only optical disk such as CD-ROM or DVD-ROM, a recordable optical disk such as CD-R or DVD-R, or a rewritable optical disk.

A transparent material resistant to radiant heat applied thereto when the medium is used on an OHP or back light display is preferable as the material for the transparent substrate. Examples of the material include polyesters such as polyethylene terephthalate (PET), polysulfone, polyphenylene oxide, polyimide, polycarbonate, polyamide and the like. Among them, polyesters are preferable, and polyethylene terephthalate is particularly preferable.

While the thickness of the transparent substrate is not particularly limited, it is preferably in the range of 50 to 200 μm from the viewpoint of ease of handling.

The high-gloss opaque substrate preferably has a glossiness of 40% or more on the surface where the ink-receiving layer is formed. The glossiness is a value determined by a known method taught by ISO 8254-1, i.e., Paper and board—Measurement of specular gloss—Part 1: 75 degree gloss with a converging beam. Specific examples of the substrates include the following:

Specific examples of the high-gloss opaque substrate include: high-gloss paper substrates such as art paper, coated paper, cast-coated paper, baryta paper commonly used as a silver salt photographic substrate and the like; high-gloss films opacified by adding a white pigment or the like to any one of plastic films such as polyesters such as polyethylene terephthalate (PET), nitrocellulose, cellulose acetate, cellulose esters such as cellulose acetate butylate, polysulfone, polyphenylene oxide, polyimide, polycarbonate, polyamide or the like (which may be additionally surface calendered); substrates having a polyolefin coating layer containing or not containing a white pigment formed on the surface of these various paper and transparent substrates or the high-gloss films containing a white pigment; or the like.

Foamed polyester films containing a white pigment (e.g., a foamed polyester formed by expanding a polyolefin microparticle-containing PET film so, as to forming voids therein) are favorable and also included as examples. In addition, resin coated papers commonly used as photographic papers for silver salt photographs are also preferable.

While the thickness of the opaque substrate is not particularly limited, it is preferably in a range of 50 to 300 μm from the viewpoint of ease of handling.

The surface of substrate may be subjected to corona discharge treatment, glow discharge treatment, flame treatment, ultraviolet ray irradiation treatment or the like for improvement in wetting property and adhesiveness.

Hereinafter, base paper for the resin-coated paper will be described in detail.

The base paper is prepared by using wood pulp as a primary raw material, and further using a synthetic pulp such as polypropylene or a synthetic fiber such as nylon or polyester in accordance with necessity. While the wood pulp may be any one of LBKP, LBSP, NBKP, NBSP, LDP, NDP, LUKP, and NUKP, it is preferable to use LBKP, NBSP, LBSP, NDP, and LDP, which contain a greater amount of short fibers.

The ratio of LBSP and/or LDP is 10% or more and 70% or less by mass.

Chemical pulps (such as sulfate salt pulp or sulfite pulp) containing a smaller amount of impurities are preferably used as the pulp used in the invention. Bleached pulps which are improved in whiteness are also useful.

Various additives including a sizing agent such as higher fatty acid or alkylketene dimer, a white pigment such as calcium carbonate, talc or titanium oxide, a paper-strength additive such as starch, polyacrylamide or polyvinyl alcohol, a fluorescent whitening agent, a moisturizing agent such as polyethylene glycols, a dispersing agent, a softener such as quaternary ammonium, and the like may be added to the base paper in accordance with necessity.

The freeness of the pulp for use in sheeting is preferably 200 to 500 ml as per CSF (Canadian Standard Freeness) regulations In regard to the fiber length after beating, the pulps remaining on 24- and 42-mesh screens is preferably 30 to 70% by mass, as determined by the known method taught by ISO 534, i.e., Paper and board—Determination of thickness and density. Further, the pulp remaining on 4-mesh screen is preferably 20% by mass or less.

The basis weight of the base paper is preferably 30 to 250 g and more preferably 50 to 200 g. The thickness of the base paper is preferably 40 to 250 μm. The base paper may be calendered to improve surface smoothness during or after sheeting. The density of the base paper is generally 0.7 to 1.2 g/m² as determined by the known test procedure for determination the thickness and density of paper.

In addition, the stiffness of the base paper is preferably 20 to 200 g as determined by the known test procedure for determining the stiffness of paper by using a Clark stiffness tester.

A surface-sizing agent may be applied to the surface of the base paper, and sizing agents similar to those that may be added to the base paper can be used as the surface sizing agent. The pH of the base paper is preferably 5 to 9, as determined by the known hot-water extraction method specified in the test for determining the tensile properties of paper.

The polyethylene covering the front and rear surfaces of the base paper is mainly a low-density polyethylene (LDPE) and/or a high-density polyethylene (HDPE), but other LLDPE, polypropylene, or the like may also be used partially.

In particular, the polyethylene layer on which the ink-receiving layer is provided is preferably formed of polyethylenes containing rutile-titanium oxide, anatase-titanium oxide, a fluorescent whitening agent, and/or ultramarine that are improved in opacity, whiteness and hue, which are commonly used in photographic papers. The content of the titanium oxide is preferably in a range of about 3 to 20% and more preferably in a range of 4 to 13% by mass with respect to the polyethylene. The thickness of the polyethylene layer, either front or rear, is not particularly limited, but is favorably in a range of 10 to 50 μm. In addition, an undercoat layer may be formed on the polyethylene layer for increasing the adhesiveness thereof to an ink-receiving layer. Hydrophilic polyester, gelatin, and PVA are preferable for the undercoat layer. The thickness of the undercoat layer is preferably in a range of 0.01 to 5 μm.

The polyethylene-coated paper may be used as a glossy paper.

The polyethylene layer coated on the surface of the base paper by melt-extrusion may be further subjected to a surface modification treatment such as embossing so that it has a mat or silky surface similar to that of common photographic printing papers.

Additionally, a backcoat layer may also be formed on the substrate, and components such as white pigment, aqueous binder, and other components may be added to the backcoat layer.

Examples of the white pigments contained in the backcoat layer include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous soil, calcium silicate, magnesium silicate, synthetic amorphous silica, colloidal silica, colloidal alumina, pseudoboehmite, aluminum hydroxide, alumina, lithopone, zeolite, hydrated hallosite, magnesium carbonate, or magnesium hydroxide; organic pigments such as styrene plastic pigment, acrylic plastic pigment, polyethylene, microcapsule, urea resin, or melamine resin; and the like.

Examples of the aqueous binders for use in the backcoat layer include water-soluble polymers such as styrene/maleic acid salt copolymers, styrene/acrylic salt copolymers, polyvinyl alcohol, silanol-modified polyvinyl alcohols, starch, cationic starch, casein, gelatin, carboxymethylcellulose, hydroxyethylcellulose, or polyvinylpyrrolidone; water-dispersible polymers such as styrene butadiene latexes or acryl emulsions; and the like.

The other components contained in the backcoat layer include defoaming agent, antifoaming agent, dye, fluorescent whitening agent, antiseptic, water-resistance imparting agent, and the like.

The ink-receiving layer of the ink jet recording medium of the invention can be formed by a process including applying the ink-receiving layer coating liquid according to the invention onto a support to form a coated layer, and then applying heating and drying treatments and the like to the coated layer in accordance with necessity. It is desirable that the preparation process further includes applying, onto the coated layer, a basic coating liquid having a pH of 7.1 or more at a time of any one of: (1) at the same time as the coating liquid is applied; (2) during a period in which the coated layer is drying before the coated layer exhibits a decrease in the rate of drying; or (3) after the coated layer is dried to form a coating film.

It is desirable to provide the ink-receiving layer thus cured by crosslinking in view of its ink absorbability, the prevention of cracking, and the like.

It is preferable that the mordant is provided to the ink-receiving layer in the above-described manner since a large amount of a mordant can be present in the vicinities of the surface of the ink-receiving layer so as to sufficiently mordant color materials for ink jet recording, whereby water resistances of printed characters and picture images are improved.

A preparation for the ink-receiving layer coating liquid according to the invention may be performed by grain-refining prescribed constituent materials by using a disperser. While examples of the disperser for preparing the dispersion include a variety of well known dispersers such as a high-speed rotation disperser, a medium agitation disperser (such as a ball mill or a sand mill), an ultrasonic disperser, a colloid mill disperser, high-pressure disperser or the like, the agitation disperser, the colloid mill disperser, and the high-pressure disperser are preferable from the viewpoint of achieving efficient dispersing of lump fine particles formed.

Examples of the solvent in the coating liquid include water, organic solvents, and solvents prepared by mixing these. Examples of the organic solvents include: alcohols such as methanol, ethanol, n-propanol, i-propanol or methoxypropanol; ketones such as acetone or methyl ethyl ketone; tetrahydrofuran; acetonitrile; ethyl acetate; toluene and the like.

A dispersing agent may be added to the coating liquid in order to improve the dispersibility of the coating liquids. Cationic polymers may be used for the dispersing agent. Examples of the cationic polymers include those referred as the examples of the mordant. In addition, a silane coupling agent may be used as the dispersing agent.

An amount of the dispersing agent to be added is preferably in a range of 0.1 to 30 mass %, and more preferably in a range of 1 to 10 mass %, relative to an amount of the inorganic fine particles.

Application of the ink-receiving layer coating liquid can be carried out by a known coating method using, for example, an extrusion die coater, an air doctor coater, a bread coater, a rod coater, a knife coater, a squeeze coater, a reverse roll coater, a bar coater or the like.

The phrase “before the coated layer exhibits a decreasing rate of drying” as used herein usually means a lapse of time of several minutes from immediately after application of the ink receiving layer coating liquid. The “constant rate drying” phenomenon is the period in which the content of the solvent (dispersion medium) in the applied coated layer is reduced in proportion to the lapse of time. The period exhibiting the “constant rate drying” is described in Kagaku Kogaku Binran (Handbook of Chemical Engineering; pp. 707-712, Maruzen Co., Ltd., Oct. 25, 1980).

The period in which the ink receiving layer is dried until the coated layer exhibits a decreasing rate of drying after applying the first coating liquid is usually 0.5 to 10 minutes (preferably 0.5 to 5 minutes) at 50 to 180° C. Although the drying period is naturally different depending on the amount of coating, the range above is usually appropriate.

Examples of methods for application of a second layer coating liquid before the first coated layer exhibits a decreasing rate of drying include (1) a method of additionally coating the second layer coating liquid on the first coated layer, (2) a spraying method, and (3) a method for dipping the substrate comprising the coated layer thereon in the second layer coating liquid.

Method available for applying the second layer coating liquid in the method (1) include methods known in the art such as using a curtain flow coater, extrusion die coater, air doctor coater, blade coater, rod coater, knife coater, squeeze coater, reverse roll coater and bar coater. The methods of using a extrusion die coater, curtain flow coater or bar coater are preferable, since these methods are able to apply the coat without making direct contact with the already formed first coated layer.

After applying the second layer coating liquid, it is usually heated at 40 to 180° C. for 0.5 to 30 minutes for drying and hardening. Within the range conditions, heating at 40 to 150° C. for 1 to 20 minutes is preferable.

When the second layer coating liquid is applied at substantially the same time as applying the first layer coating liquid, the first layer coating liquid and the second layer coating liquid can be simultaneously applied (multi-layer application) on the substrate so that the first layer coating liquid contacts the substrate, followed by hardening by drying the liquids to form the ink receiving layer.

The above-described simultaneous application (multi-layer application) can be performed by the coating method using the extrusion die coater, the curtain flow coater, or the like. While the coated layer formed is usually dried by heating at 40 to 150° C. for 0.5 to 10 minutes after the simultaneous application, the drying conditions is preferably set at 40 to 100° C. for 0.5 to 5 minutes.

When the coating liquids are applied so as to form a multi-layer with the extrusion die coater, for example, the multi-layer is formed in the vicinity of the discharge port of the extrusion die coater by simultaneously discharging the two kinds of the coating liquids before transferring onto the substrate, in order to directly form the dual coated layer. Before application the two kinds of the coating liquids in the multi-layer tend to form cross-links, at the interface between the two solutions, before being transferred onto the substrate. Hence the two solutions are liable to be thickened by being mixed with each other in the vicinity of the discharge port of the extrusion die coated. This may make the coating operation difficult. Accordingly, it is preferable to simultaneously form a triple layer by making a barrier layer coating liquid (an intermediate layer coating liquid) interpose between the first layer coating liquid and the second layer coating liquid.

The barrier layer coating liquid may be selected without any restrictions, and examples thereof include an aqueous solution containing a trace amount of a water soluble resin, water, and the like. The water soluble resin is added as a thickener for improving coating performance. Examples of water soluble resins include cellulose resins (such as hydroxylpropylmethyl cellulose, methyl cellulose or hydroxyethyl cellulose), polyvinyl pyrrolidone and gelatin. The above-described mordant may further be added to the barrier layer coating liquid.

The surface smoothness, glossiness, transparency and strength of coated layer may be improved by applying calender treatment by heating and passing the sheet through roll nips under pressure, using a super calender or gloss calender machine after forming the ink receiving layer is formed on the substrate. However, since in some cases the calender treatment may cause a decrease of the void ratio (resulting in a decrease in ink absorbing property), conditions that give a small decrease of the void ratio should be employed.

The roll temperature for applying the calender treatment is preferably in a range of 30 to 150° C., more preferably in a range of 40 to 100° C.

The linear pressure between the rolls for calender treatment is preferably in a range of 50 to 400 kg/cm, more preferably in a range of 100 to 200 kg/cm.

The ink receiving layer is required to have a thickness that renders an absorption capacity enough for absorbing all the provided droplets in case of being subjected to ink-jet recording. Therefore, the thickness should be determined in relation to the void ratio in the layer. For example, the thickness should be equal to or more than about 15 μm when the amount of the ink is 8 nl/mm² and the void ratio is 60%.

The thickness of the ink receiving layer is preferably in a range of 10 to 50 μm for ink-jet recording considering the conditions above.

The median diameter of the voids in the ink receiving layer is preferably in a range of 0.005 to 0.030 μm, more preferably in a range of 0.01 to 0.025 μm.

The void ratio and median diameter can be measured using a mercury porosimeter (trade name: Poresizer 9320-PC2, manufactured by Shimadzu Corporation).

It is preferable that the ink receiving layer has excellent transparency. The criterion of transparency is that the ink receiving layer formed on a transparent film substrate preferably has a haze value of 30% or less, and more preferably 20% or less.

The haze value is measured using a haze meter (trade name: HGM-2DP, manufactured by Suga Test Instrument Co., Ltd.).

A dispersion of polymer fine particles may be added to the constituting layers (such as the ink receiving layer or the back layer) of the ink jet recording sheet of the invention. This polymer fine particle dispersion is used for improving film properties such as dimensional stability, curl prevention, adhesion prevention and crack prevention. Suitable polymer fine particle dispersion are described in each of the publications JP-A Nos. 62-245258, 62-1316648 and 62-110066. Cracking and curling of the layer can be prevented by adding a polymer fine particle dispersion having a low glass transition temperature (40° C. or less) to the layer. Curling may be also prevented by adding a polymer fine particle dispersion having a high glass transition temperature to the back layer.

The ink-jet recording medium of the invention can alternatively be made by any one of methods described in JP-A Nos. 10-81064, 10-11942, 10-15727, 10-21760, 11-34840, 2001-138621, 2000-43401, 2000-211235, 2000-309157, 2001-96897, 2001-138627, 11-91242, 8-2087, 8-2090, 8-2091, and 8-2093.

### EXAMPLES

Hereinafter, the present invention is described in more detail by reference to the Examples, while the invention is not limited to the Examples. In the Examples, the terms “parts” and “%” refer to “parts by mass” and “% by mass” respectively, and the terms “average molecular weight” and “polymerization degree” refer to “weight-average molecular weight” and “mass-average polymerization degree” respectively, unless otherwise specified.

### Preparation of Substrate

Wood pulp composed of 50 parts of LBKP was beaten with a disk refiner to a Canadian freeness of 300 ml so as to prepare a pulp slurry.

Then, 1.3% of a cationic starch (trade name: CATO 304L, manufactured by Japan NSC Corporation), 0.15% of anionic polyacrylamide (trade name: POLYACRON ST-13, manufactured by Seiko Chemical Corporation), 0.29% of an alkylketene dimer (trade name: SIZEPINE K, manufactured by Arakawa Chemical Industries, Ltd.), 0.29% of epoxylated behenic acid amide, and 0.32% of polyamide-polyamine-epichlorohydrin (trade name: ARAFIX 100, manufactured by Arakawa Chemical Industries, Ltd.) (each of the percentages is calculated relative to the amount of the pulp) were added to the thus-obtained pulp slurry, and thereafter, 0.12% of a deformer was added therto.

The thus-prepared pulp slurry was applied to form paper by using a Fourdrinier paper machine, and dried such that a tensile force of a dryer canvas was set at 1.6 kg/cm during drying the pulp slurry by pushing a felt surface of a web of the machine to a drum dryer cylinder through a dryer canvas so as to obtain a base paper. Thereafter, both surfaces of the base paper were coated with 1 g/m² of polyvinyl alcohol (trade name: KL-118, manufactured by Kraray Co., Ltd.) by the use of a size press, dried, and subjected to a calendering treatment. The base paper was made so as to have 166 g/m² basic weight, and the thus-obtained base paper (substrate) having 160 μm thickness.

After subjecting the wire surface (back surface) of the substrate paper to corona electrical discharge treatment, the surface was coated to a thickness of 25 μm with high density polyethylene using an extrusion machine so as to form a thermoplastic resin layer consisted of a matt surface (hereinafter this thermoplastic resin layer surface will be referred to as the ‘back surface’). Further corona electrical discharge treatment was carried out on the thermoplastic resin layer of this back surface. Then, as an anti-static agent, a dispersion liquid containing aluminium oxide (trade name: ALUMINASOL 100, manufactured by Nissan Chemical Industries Ltd) and silicon dioxide (trade name: SNOWTEX O; manufactured by Nissan Chemical Industries Ltd) at a mass ratio of 1:2 dispersed in water was coated thereon so that a dry weight of the anti-static agent became 0.2 g/m².

In addition, on the felt surface (face surface), the side which has not been provided with a resin layer, after undertaking corona electrical discharge treatment, a high gloss thermoplastic resin,as formed by providing, on the face surface of the substrate paper (hereinafter this high gloss thermoplastic resin layer surface is referred to as the “front surface”), a with low density polyethylene having a MFR (melt flow rate) of 3.8 and adjusted by adding anatase titanium dioxide to a quantity of 10%, ultramarine to a trace quantity, and further adjusted with 0.01% of optical brightening agent (relative to polyethylene) to a thickness of 29 μm using an extrusion machine. The thus obtained material was used as the substrate in the Example.

### Preparation of Inorganic Fine Particle Dispersion

### 1) Preparation of Inorganic Fine Particle Dispersion A

Among the following composition, (1) vapor-phase process silica fine particles (1) were added to an aqueous solution containing (2) ion-exchange water, (3) a polymer 1 (the structure thereof is shown below), and (4) ammonium carbonate. The resulting mixture was dispersed by using a non-media disperser (e.g. an ultrasonic disperser manufactured by SMT Co., Ltd.), thereafter, the dispersion was heated at 45° C., and maintained for 20 hours, whereby an inorganic fine particle dispersion A (dispersion A) was prepared.

### Formulation of the Inorganic Fine Particle Dispersion A

| | | |
|---|---|---|
| (1) | Vapor-phase process silica fine particle (inorganic fine | 10.0 parts |
| | particles) (trade name: AEROSIL 300SF75, | |
| | manufactured by Nippon Aerosil Co. Ltd.; | |
| | average primary particle diameter 7 nm) | |
| (2) | Ion-exchange water | 52.4 parts |
| (3) | Polymer 1 (silane coupling agent) (mean molecular | 4.0 parts |
| | weight Mw: 20,000: 25% ethanol solution) | |
| (4) | Ammonium carbonate manufactured (by Kanto Chemical | 0.21 parts |
| | Co., Inc.) | |

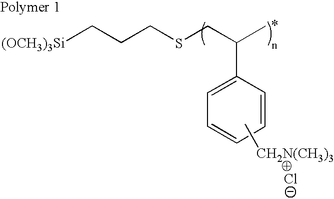

### Preparation of Dispersions B to Y

Inorganic fine particle dispersions B to Y were prepared in accordance with the same manner as that of the inorganic fine particle dispersion A except that the amounts of the polymer 1 and ammonium carbonate used in the inorganic fine particle dispersion A were changed into the kinds and the ratios shown in the following Table 1.

TABLE 1

| | | Ammonium | |
|---|---|---|---|
| | | Carbonate Amount | |
| Dispersion | Polymer | Added [Part] | Remarks |
| Dispersion L | Polymer 1 | — | Silane Coupling |
| Dispersion A | | 0.21 | Agent |
| Dispersion B | | 0.31 | |
| Dispersion C | | 0.44 | |
| Dispersion D | | 0.49 | |
| Dispersion M | | 0.67 | |
| Dispersion N | Polymer 2 | — | |
| Dispersion E | | 0.44 | |
| Dispersion O | Polymer 3 | — | |
| Dispersion F | | 0.18 | |
| Dispersion G | | 0.32 | |
| Dispersion H | | 0.48 | |
| Dispersion P | | 0.88 | |
| Dispersion Q | Polymer 4 | — | |
| Dispersion I | | 0.18 | |
| Dispersion J | | 0.32 | |
| Dispersion K | | 0.48 | |
| Dispersion R | | 0.70 | |
| Dispersion S | Polymer 5 | — | Non-Silane Coupling |
| Dispersion T | | 0.27 | Agent |
| Dispersion U | | 0.49 | |
| Dispersion V | | 0.67 | |
| Dispersion W | Polymer 6 | — | |
| Dispersion X | | 0.56 | |
| Dispersion Y | | 1.1 | |

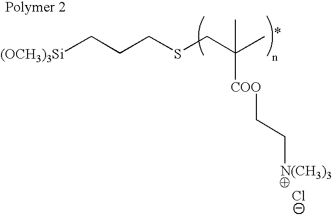

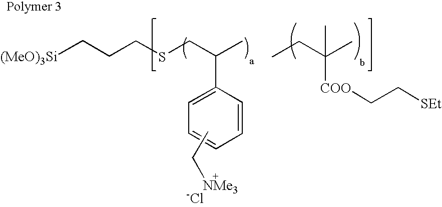

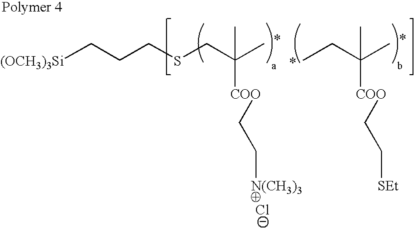

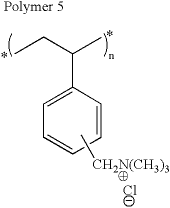

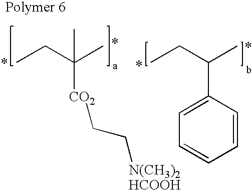

The molecular weight (Mw) of the polymer 2 is 20,000. The Mw of the polymer 3 is 20,000. The Mw of the polymer 4 is 20,000. The Mw of the polymer 5 is 30,000. Further, the Mw of the polymer 6 is 50,000. Furthermore, the ratio of the unit repeating numbers a and b (a:b) of the polymer 3 is 50:50, that of the polymer 4 is 50:50, and that of the polymer 6 is 66:34. The star mark in the structure of the polymers 1 to 6 means a position for bonding to an adjacent repeating unit.

### EXAMPLE 1

### Preparation of Ink-Receiving Layer Coating Liquid A

The ink-receiving layer coating liquid A (coating liquid A) was prepared by adding the (1) inorganic fine particle dispersion A, (2) boric acid, (3) a polyvinyl alcohol solution, (4) ethanol, and (5) ion-exchange water having the following composition at 30° C.

### Formulations of Ink-Receiving Layer Coating Liquid A

| | |
|---|---|
| (1) Inorganic fine particle dispersion A | 66.7 parts |
| (2) Boric acid | 0.38 part |
| (3) Polyvinyl alcohol (water-soluble resin) solution | 29.1 parts |
| (4) Ethanol | 2.6 parts |
| (5) Ion-exchange water | 4.3 parts |

### Formulation of Polyvinyl Alcohol Solution

| | |
|---|---|
| Polyvinyl alcohol (trade name: PVA 235, | 2.0 parts |
| manufactured by Kraray Co., Ltd.; saponification | |
| degree: 88%; polymerization degree: 3500) | |
| Polyoxyethylene lauryl ether (surfactant) | 0.75 part |
| (trade name: EMALGEN 109P, manufactured by | |
| Kao Corporation; (10% aqueous | |
| solution), HLB value: 13.6) | |
| Diethylene glycol monobutyl ether (trade name: | 0.66 part |
| BUTYCENOL 20P, manufactured by | |
| Kyowa Hakko Co., Ltd.) | |
| Viscosity depressant (EDTA-diamide) | 0.055 part |
| Ion-exchange water | 26.1 parts |

### Preparation of Ink Jet Recording Medium

The front surface of the support was subjected to corona discharge treatment, and then, the ink-receiving layer coating liquid A of Example 1 was applied thereto such that an applied amount thereof was 183 ml/m². 8% by mass of polychlorinated aluminum aqueous solution (trade name: ALFINE 83, manufactured by Taimei Chemicals Co., Ltd.) was admixed with the ink-receiving layer coating liquid A so that a coating amount thereof became 12.0 ml/m² immediately before the application. Further, the coated layer was dried at 80° C. (3 to 8 m/sec wind velocity) with a hot-air dryer until the solid concentration of the coated layer reaches 20%. During the drying, the coated layer exhibited a constant rate of drying speed. Before the coated layer exhibits a decreasing rate of drying, it was immersed in a basic coating liquid C having the following composition for three seconds so that an amount thereof adhered onto the coated layer became 13 g/m². Further, the resulting product was dried at a temperature of 80° C. for ten minutes (curing). Thus, an ink jet recording medium on which an ink-receiving layer having 32 μm dry film thickness has been provided was fabricated.

### Formulation of Basic Solution C

| | |
|---|---|
| (1) Boric acid | 0.65 part |
| (2) Ammonium zirconium carbonate | 2.5 parts |
| (trade name: ZIRCOSOL AC-7 (28% | |
| aqueous solution), manufactured | |
| by Daiichi Kigenso Kagaku Kogyo Co., Ltd.) | |
| (3) Ammonium carbonate (first class; manufactured | 3.5 parts |
| by Kanto Chemical Co., Inc.) | |
| (4) Ion-exchange water | 63.3 parts |
| (5) Polyoxyethylene lauryl ether (surfactant) | 30.0 parts |
| (trade name: EMALGEN 109P (2% aqueous | |
| solution), HLB value 13.6, manufactured | |
| by Kao Corporation) | |

### Examples 2 to 11 and Comparative Examples 1 to 14

The ink jet recording media of Example 2 to 11 and Comparative examples 1 to 14 were prepared in the same manner as that of Example 1 except that each of the inorganic fine particle dispersions shown in the following Table 2 was used in place of the inorganic fine particle dispersion A. It is to be noted that the coating liquids, the viscosity of which exceeded 500 cp in the next day after the preparation thereof, were respectively diluted with ethanol so as to be applied for coating.

Each of the inorganic fine particle dispersions, the ink-receiving layer coating liquids, and the ink jet recording media obtained as described above was evaluated in the following manners. The results obtained are shown in Table 2.

### (1) Measurement of pH of Inorganic Fine Particle Dispersion

pH was measured by using a pH measuring apparatus (trade name: HM-25G, manufactured by DKK.Toa Corporation).

### (2) Dispersibility

The dispersibility of the vapor-phase process silica fine particles exhibited during preparation of the inorganic fine particle dispersion was visually observed, and the result was evaluated on the basis of the following criteria.

Good dispersibility (charging of the silica is easy): A

Slightly poor dispersibility (charging of the silica takes time): B

Poor dispersibility (manual assistance from the outside is required for charging of the silica): X

### (3) Measurement of Viscosity of Ink-Receiving Layer Coating Liquid

Viscosity of the ink-receiving layer coating liquid was measured by using a B-type viscometer manufactured by Tokimec Inc. Further, the viscosity of the coating liquid measured using INCUBATOR (trade name MIR-253, manufactured by Sanyo Electric Co., Ltd.) so as to keep the ink-receiving layer coating liquid after the preparation at 30° C. for one day was taken as the viscosity of the coating liquid after lapse of one day.

### (4) Evaluation of Surface Condition of Ink Jet Recording Medium

A surface condition of each of the ink jet recording media prepared by coating was visually observed, and evaluation was conducted in accordance with the following criteria.

No crack was observed: A

Cracks were observed (around five problems in plate L size): B

Cracks were observed (around ten problems in plate L size): X

TABLE 2

| | | | | | | Viscosity [cp] of Coating | | | |
|---|---|---|---|---|---|---|---|---|---|
| | | | | | | Liquid | | | |
| | | | | | | Immediately | After Lapse | | |
| | | | Dispersion | | Coating | After | of 1 Day from | Surface | |
| | Polymer | Dispersion | pH | Dispersibility | Liquid | Preparation | Preparation | Condition | Remarks |
| Comparative | Polymer 1 | Dispersion L | 3.1 | A | Coating | 210 | 1010 | A | Silane |
| Example 1 | | | | | Liquid L | | | | Coupling |
| Example 1 | | Dispersion A | 4.1 | A | Coating | 53 | 70 | A | Agent |
| | | | | | Liquid A | | | | |
| Example 2 | | Dispersion B | 4.4 | A | Coating | 53 | 63 | A | |
| | | | | | Liquid B | | | | |
| Example 3 | | Dispersion C | 4.8 | A | Coating | 50 | 55 | A | |
| | | | | | Liquid C | | | | |
| Example 4 | | Dispersion D | 4.9 | B | Coating | 53 | 60 | A | |
| | | | | | Liquid D | | | | |
| Comparative | | Dispersion M | 5.2 | X | Coating | 73 | 73 | A | |
| Example 2 | | | | | Liquid M | | | | |
| Comparative | Polymer 2 | Dispersion N | 3.2 | A | Coating | 511 | 3700 | X | |
| Example 3 | | | | | Liquid N | | | | |
| Example 5 | | Dispersion E | 4.7 | A | Coating | 60 | 65 | A | |
| | | | | | Liquid E | | | | |
| Comparative | Polymer 3 | Dispersion O | 3.0 | A | Coating | 315 | 2200 | B | |
| Example 4 | | | | | Liquid O | | | | |
| Example 6 | | Dispersion F | 3.7 | A | Coating | 105 | 223 | A | |
| | | | | | Liquid F | | | | |
| Example 7 | | Dispersion G | 4.2 | A | Coating | 105 | 170 | A | |
| | | | | | Liquid G | | | | |
| Example 8 | | Dispersion H | 4.6 | B | Coating | 130 | 243 | A | |
| | | | | | Liquid H | | | | |
| Comparative | | Dispersion P | 5.4 | X | Coating | 10000 | —* | X | |
| Example 5 | | | | | Liquid P | | | | |
| Comparative | Polymer 4 | Dispersion Q | 2.8 | A | Coating | 440 | 1320 | A | |
| Example 6 | | | | | Liquid Q | | | | |
| Example 9 | | Dispersion I | 3.4 | A | Coating | 123 | 178 | A | |
| | | | | | Liquid I | | | | |
| Example 10 | | Dispersion J | 4.2 | A | Coating | 80 | 98 | A | |
| | | | | | Liquid J | | | | |
| Example 11 | | Dispersion K | 4.6 | B | Coating | 93 | 113 | A | |
| | | | | | Liquid K | | | | |
| Comparative | | Dispersion R | 5.2 | X | Coating | 500 | 1560 | B | |
| Example 7 | | | | | Liquid R | | | | |
| Comparative | Polymer 5 | Dispersion S | 2.9 | A | Coating | 4350 | —* | X | Non-silane |
| Example 8 | | | | | Liquid S | | | | Coupling |
| Comparative | | Dispersion T | 4.0 | A | Coating | 3150 | —* | X | Agent |
| Example 9 | | | | | Liquid T | | | | |
| Comparative | | Dispersion U | 4.7 | A | Coating | 4550 | —* | X | |
| Example 10 | | | | | Liquid U | | | | |
| Comparative | | Dispersion V | 5.0 | A | Coating | 4450 | —* | X | |
| Example 11 | | | | | Liquid V | | | | |
| Comparative | Polymer 6 | Dispersion W | 3.9 | A | Coating | 106 | 305 | A | |
| Example 12 | | | | | Liquid W | | | | |
| Comparative | | Dispersion X | 4.3 | X | Coating | 134 | 440 | A | |
| Example 13 | | | | | Liquid X | | | | |
| Comparative | | Dispersion Y | 4.7 | X | Coating | 171 | 780 | B | |
| Example 14 | | | | | Liquid Y | | | | |

Since the coating liquid gelled, the viscosity cannot be measured.

Viscosities of the coating liquids after lapse of one day in Comparative examples 5, 8, 9, 10, and 11 could not be measured, because the coating liquids gelled.

As is understood from Table 2, the coating liquids in Examples 1 to 11 exhibited good dispersibility, and in addition, increase in the viscosity of the coating liquids with the lapse of time were suppressed. It is supposed that these effects were obtained because the pH of a dispersion is adjusted to be in the region, in which the adsorption ratio of the silane coupling agent with respect to the silica is increased, so that adsorption of PVA onto the silica is suppressed by encompassing larger number of the silica fine particles with the silane coupling agent.

Viscosities of the coating liquids in Comparative examples 1, 3, 4, and 6 increased with time lapse to such a level at which coating cannot be conducted therewith. In this respect, it is supposed that since the pH of a dispersion is not adjusted, adsorption of the silane coupling agent onto the silica became insufficient so that adsorption of PVA onto the silica cannot be suppressed.

With regard to Comparative examples 2, 5, and 7, viscosities of the coating liquids used therein increased, and the surface conditions thereof after the application of the coating liquids were poor. In this respect, it is supposed that although an adsorption ratio of the silane coupling agent onto the silica is improved due to pH adjustment of the dispersion, the zeta potential among the silica particles decreased, and electrostatic repulsion among silica particles weakened, resulting in a condition in which the silica particles tend to aggregate.

No effect for stabilizing viscosity of the coating liquid was observed in Comparative examples 8 to 14. In this respect, it is supposed that since the polymers, each of which has no bonding site to the silica, are used, electrostatic repulsion among the silica particles simply weaken even if the pHs are adjusted.

This application claims priority under 35USC 119 from Japanese Patent Application No. 2006-41335, the disclosure of which is incorporated by reference herein.

What is claimed is:

1. An inorganic fine particle dispersion comprising inorganic fine particles, a silane coupling agent, and at least one member selected from the group consisting of a basic inorganic salt and ammonium, the inorganic fine particle dispersion having a pH of 5.0 or less.

2. The inorganic fine particle dispersion according to claim 2, wherein the silane coupling agent is a cationic polymer-silane coupling agent.

3. The inorganic fine particle dispersion according to claim 2, wherein the cationic polymer-siilane coupling agent is represented by the following Formula (1): 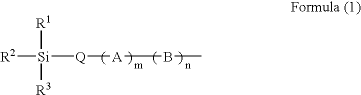
wherein in Formula (1): each of R¹, R², and R³ independently represents a hydrogen atom, an alkyl group which has 1 to 18 carbon atoms and may include a saturated or unsaturated cyclic structure, an alkoxy group which has 1 to 8 carbon atoms and may include a saturated or unsaturated cyclic structure, or an aryloxy group; at least one of R¹, R², and R³ is an alkoxy group or an aryloxy group; Q represents a substituted or unsubstituted divalent linking group having 1 to 18 carbon atoms and which may include adjacent moieties linked through a heteroatom; A represents a repeating unit provided by a cationic monomer; B represents a repeating unit provided by a nonionic monomer; and each of m and n independently represents a mole percentage of the A component or the B component, wherein each of m and n is independently in a range of 0 to 100 mol %.

4. The inorganic fine particle dispersion according to claim 2, wherein the cationic polymer-silane coupling agent is represented by the following Formula (2): 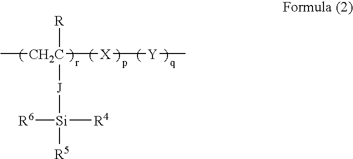
wherein in Formula (2): each of R⁴, R⁵, and R⁶ independently represents a hydrogen atom, an alkyl group which has 1 to 18 carbon atoms and may include a saturated or unsaturated cyclic structure, an alkoxy group which has 1 to 8 carbon atoms and may include a saturated or unsaturated cyclic structure, or an aryloxy group; at least one of R⁴, R⁵, and R⁶ is an alkoxy group or an aryloxy group; J represents a substituted or unsubstituted divalent linking group having 1 to 18 carbon atoms and which may include adjacent moieties linked through a heteroatom; X represents a repeating unit provided by a cationic monomer; Y represents a repeating unit provided by a nonionic monomer; each of r, p, and q represents a mole percentage of the respective repeating unit, wherein r is in a range of 1 to 50 mol %, each of p and q is independently in a range of 0 to 99 mol %; and R represents a hydrogen atom or an alkyl group having 1 to 4 carbon atoms.

5. The inorganic fine particle dispersion according to claim 1, wherein the inorganic fine particles are selected from the group consisting of silica fine particles, colloidal silica, alumina fine particles and pseudo-boehmite.

6. A method for forming an inorganic fine particle dispersion comprising inorganic fine particles, a silane coupling agent, and at least one member selected from the group consisting of a basic inorganic salt and ammonium, the inorganic fine particle dispersion having a pH of 5.0 or less, the method comprising
adjusting the pH of the dispersion by using the at least one member selected from the group consisting of the basic inorganic salt and the ammonium.

7. The method for forming an inorganic fine particle dispersion according to claim 6, further comprising dispersing the inorganic fine particles into a liquid containing the at least one member selected from the group consisting of the basic inorganic salt and the ammonium.

8. A method for manufacturing an ink jet recording medium comprising a support and, provided on the support, an ink-receiving layer that comprises a water-soluble resin, inorganic fine particles, a silane coupling agent, and at least one member selected from the group consisting of a basic inorganic salt and ammonium, the method comprising:
preparing an inorganic fine particle dispersion having a pH of 5.0 or less and comprising the inorganic fine particle, the silane coupling agent, and the at least one member selected from the group consisting of the basic inorganic salt and the ammonium;
preparing an ink-receiving layer coating liquid by mixing the inorganic fine particle dispersion and the water-soluble resin; and
applying the ink-receiving layer coating liquid onto the support to form a coated layer.

9. The method for manufacturing an ink jet recording medium according to claim 8, wherein the silane coupling agent is a cationic polymer-silane coupling agent.

10. The method for manufacturing an ink jet recording medium according to claim 9, wherein the cationic polymer-silane coupling agent is represented by the following Formula (1): 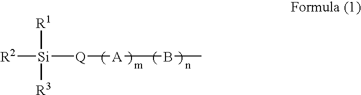
wherein in Formula (1): each of R¹, R², and R³ independently represents a hydrogen atom, an alkyl group which has 1 to 18 carbon atoms and may include a saturated or unsaturated cyclic structure, an alkoxy group which has 1 to 8 carbon atoms and may include a saturated or unsaturated cyclic structure, or an aryloxy group; at least one of R¹, R², and R³ is an alkoxy group or an aryloxy group; Q represents a substituted or unsubstituted divalent linking group having 1 to 18 carbon atoms and which may include adjacent moieties linked through a heteroatom; A represents a repeating unit provided by a cationic monomer; B represents a repeating unit provided by a nonionic monomer; and each of m and n independently represents a mole percentage of the A component or the B component, wherein each of m and n is independently in a range of 0 to 100 mol %.

11. The method for manufacturing an ink jet recording medium according to claim 9, wherein the cationic polymer-silane coupling agent is represented by the following Formula (2): 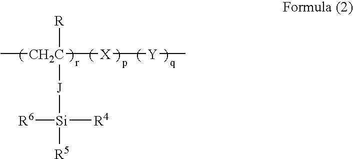
wherein in Formula (2): each of R⁴, R⁵, and R⁶ independently represents a hydrogen atom, an alkyl group which has 1 to 18 carbon atoms and may include a saturated or unsaturated cyclic structure, an alkoxy group which has 1 to 8 carbon atoms and may include a saturated or unsaturated cyclic structure, or an aryloxy group, wherein at least one of R⁴, R⁵, and R⁶ is an alkoxy group or an aryloxy group; J represents a substituted or unsubstituted divalent linking group having 1 to 18 carbon atoms and which may include adjacent moieties linked through a heteroatom; X represents a repeating unit provided by a cationic monomer; Y represents a repeating unit provided by a nonionic monomer; each of r, p, and q represents a mole percentage of the respective repeating unit, wherein the r is in a range of 1 to 50 mol %, each of p and q is independently in a range of 0 to 99 mol %; and R represents a hydrogen atom or an alkyl group having 1 to 4 carbon atoms.

12. The method for manufacturing an ink jet recording medium according to claim 8, wherein the inorganic fine particles are selected from the group consisting of silica fine particles, colloidal silica, alumina fine particles and pseudo-boehmite.

13. The method for manufacturing an ink jet recording medium according to claim 8, wherein the water-soluble resin is a polyvinyl alcohol resin.

14. The method for manufacturing an ink jet recording medium according to claim 8, wherein the ink-receiving layer further comprises a crosslinking agent that can crosslink the water-soluble resin.

15. The method for manufacturing an ink jet recording medium according to claim 14, wherein the crosslinking agent is a boron compound.

16. The method for manufacturing an ink jet recording medium according to claim 8, further comprising applying, onto the coated layer, a basic coating liquid having a pH of 7.1 or more at a time of any one of: (1) at the same time as the coating liquid is applied; (2) during a period in which the coated layer is drying before the coated layer exhibits a decrease in the rate of drying; or (3) after the coated layer is dried to form a coating film.

17. An ink jet recording medium comprising a support and, provided on the support, an ink-receiving layer that comprises a water-soluble resin, inorganic fine particles, a silane coupling agent, and at least one member selected from the group consisting of a basic inorganic salt and ammonium,
wherein the ink jet recording medium is manufactured by a method comprising:
preparing an inorganic fine particle dispersion having a pH of 5.0 or less comprising the inorganic fine particles, the silane coupling agent, and the at least one member selected from the group consisting of the basic inorganic salt and the ammonium;
preparing an ink-receiving layer coating liquid by mixing the inorganic fine particles dispersion and the water-soluble resin; and
applying the ink-receiving layer coating liquid onto the support to form a coated layer.
